(19) United States
(12) Patent Application Publication
(10) Pub. No.: US 2025/0269927 A1
(43) Pub. Date: Aug. 28, 2025

(54) SUSPENSION FORK ASSEMBLY

(71) Applicant: HAYES BICYCLE GROUP INC., Mequon, WI (US)

(72) Inventor: Nicholas William PYE, Carrboro, NC (US)

(21) Appl. No.: 19/044,547

(22) Filed: Feb. 3, 2025

Related U.S. Application Data
(60) Provisional application No. 63/556,561, filed on Feb. 22, 2024.

(51) Int. Cl. B62K 25/08; B62K 25/04

(52) U.S. Cl. CPC B62K 25/08; B62K 2025/044; B62K 2025/047; B62K 2201/08

(57) ABSTRACT

A suspension system comprising a suspension fork assembly configured to provide for compression damping is disclosed. The system may comprise a first flow control element for a first setting of compression damping and a second flow control element for a second setting of compression damping and a third flow control element for a third setting of compression damping; each flow control element is independent; each flow control element is independently selectable. Each flow control element may comprise a shim stack. A control may be configured to provide a setting for compression damping. The system may comprise an adjuster configured to provide adjustment for bypass flow for compression damping and/or to actuate a needle valve. The system may comprise an adjuster configured to provide a range of adjustment for firm suspension performance at a firm suspension setting and a range of adjustment for soft suspension performance at a soft suspension setting.

### CROSS REFERENCE TO RELATED APPLICATION

The present application claims priority to and incorporates by reference in full the following patent application: U.S. Provisional Patent Application No. 63/556,561 titled “SUSPENSION FORK ASSEMBLY” filed Feb. 22, 2024.

### FIELD

The present invention relates to a suspension fork assembly for a bicycle.

### BACKGROUND

It is known to provide a suspension fork assembly for a bicycle.

It would be advantageous to provide an improved suspension fork assembly configured to provide for compression damping.

It would be advantageous to provide an improved suspension fork assembly configured to provide for compression damping comprising a first flow control element configured for operation at a first setting of compression damping and a second flow control element configured for operation at a second setting of compression damping and a third flow control element configured to operation at a third setting of compression damping.

It would be advantageous to provide an improved suspension fork assembly configured to provide for compression damping comprising a first flow control element configured for operation at an independent first setting of compression damping and a second flow control element configured for operation at an independent second setting of compression damping and a third flow control element configured to operation at an independent third setting of compression damping.

### SUMMARY

The present invention relates to a suspension system configured to provide for compression damping comprising a first flow control element configured for operation at a first setting of compression damping; a second flow control element configured for operation at a second setting of compression damping; a third flow control element configured to operation at a third setting of compression damping; the first setting is independent of the second setting and the third setting; the second setting is independent of the first setting and third setting; the third setting is independent of the first setting and the second setting. When the first flow control element is open compression damping is provided in a lockout condition; when the second flow control element is open compression damping is provided at a firm performance; when the third flow control element is open compression damping is provided at a soft performance. The system may comprise a control for a setting for compression damping; the setting for compression damping may comprise (a) a first setting for the first flow control element or (c) a second setting for the second flow control element or (b) a third setting for the third flow control element; the first setting is selectable independent of the second setting and the third setting; the second setting is selectable independent of the first setting and the third setting; the third setting is selectable independent of the first setting and the second setting. The system may comprise a fourth flow control element configured to modify bypass flow. The system may comprise a control for a setting for compression damping; the setting may comprise (a) a lockout setting with the first flow control element set to open when the pressure is at the value determined for a blowoff condition or (b) a firm suspension setting with the second flow control element set to open when the pressure is at the value determined for firm suspension performance or (c) a soft suspension setting with the third flow control element set to open when the pressure is at the value determined for soft suspension performance. The first flow control element may comprise a shim stack; the second flow control element may comprise a shim stack; the third flow control element may comprise a shim stack. The system may comprise a control comprising a knob configured to provide a setting for compression damping. The system may comprise an adjuster configured to provide adjustment for bypass flow for compression damping comprising a dial co-located with the knob. The system may comprise an adjuster for compression damping configured to actuate a needle valve.

The present invention relates to a suspension system comprising a chamber configured to provide for compression damping in response to pressure in the chamber comprising a first flow control element configured to open when the pressure is at a first value and a second flow control element configured to open when the pressure is at a second value and a third flow control element configured to open when the pressure is at a third value; the first value for the first flow control element is independent of the second value for the second flow control element and the third value for the third flow control element; the second value for the second flow control element is independent of the first value for the first flow control element and the third value for the third flow control element; the third value for the third flow control element is independent of the first value for the first flow control element and the second value for the second flow control element. The system may comprise a control for selecting a setting for compression damping; the setting may comprise (a) a lockout setting with the first flow control element set to open when the pressure is at a value determined for a blowoff condition or (b) a firm suspension setting with the second flow control element set to open when the pressure is at a value determined for firm suspension performance or (c) a soft suspension setting with the third flow control element set to open when the pressure is at a value determined for soft suspension performance. The system may comprise an adjuster is configured to provide a range of operation for suspension performance at a setting of compression damping. The system may comprise an control configured to provide a setting for compression damping; the setting for compression damping may comprise a first setting of suspension performance and a second setting of suspension performance and a third setting of suspension performance. A setting for compression damping may comprise independent settings comprising a setting for lockout and a setting for firm suspension performance and a setting soft suspension performance. The first flow control element is configured to open when pressure is at a relatively higher threshold value above an intermediate threshold value for a first suspension performance; he second flow control element is configured to open when pressure is at the intermediate threshold value for a second suspension performance; the third flow control element is configured to open when pressure is at a relatively lower threshold value below the intermediate threshold value for a third suspension performance. The first flow control element is configured to operate at a setting to open when the pressure is at a value determined for a blowoff condition; the second flow control element configured to operate at a setting to open when the pressure is at a value determined for firm suspension performance; the third flow control element is configured to operate at a setting to open when the pressure is at a value determined for soft suspension performance. The system may comprise an adjuster configured to adjust compression damping comprising a dial at a knob configured to adjust a needle valve. The first flow control element may comprise a shim stack selectably adjustable independently from the second flow control element; the first flow control element is selectably adjustable independently from the third flow control element; the second flow control element may comprise a shim stack selectably adjustable independently from the third flow control element; the third flow control element may comprise a shim stack.

The present invention relates to a suspension system comprising a chamber configured to provide for compression damping comprising a first flow control element configured for operation at a first setting of compression damping and a second flow control element configured for operation at a second setting of compression damping and a third flow control element configured for operation at a third setting of compression damping and a fourth flow control element configured to modify the pressure produced in the chamber by stroke velocity; the first flow control element is independent of the second flow control element and the third flow control element; the second flow control element is independent of the first flow control element and the third flow control element; the third flow control element is independent of the first flow control element and the second flow control element; the first setting is selectable independent of the second setting and the third setting; the second setting is selectable independent of the first setting and the third setting; the third setting is selectable independent of the first setting and the second setting. The system may comprise an adjuster for the fourth flow control element; the adjuster is configured to provide a range of adjustment for firm suspension performance at a firm suspension setting and a range of adjustment for soft suspension performance at a soft suspension setting.

The present invention relates to a suspension system configured to provide for compression damping; the system may comprise a first flow control element configured for operation at a first setting of compression damping and a second flow control element configured for operation at a second setting of compression damping and a third flow control element configured to operation at a third setting of compression damping; the first setting is independent of the second setting and the third setting; the second setting is independent of the first setting and third setting; the third setting is independent of the first setting and the second setting. The first flow control element is independent of the second flow control element and the third flow control element; the second flow control element is independent of the first flow control element and the third flow control element; the third flow control element is independent of the first flow control element and the second flow control element. The first setting is selectable independent of the second setting and the third setting; the second setting is selectable independent of the first setting and third setting; the third setting is selectable independent of the first setting and the second setting. Compression damping at the first setting is selectable independent of the second setting and the third setting; compression damping at the second setting is selectable independent of the first setting and third setting; compression damping at the third setting is selectable independent of the first setting and the second setting.

The system may comprise a chamber configured to provide for compression damping in response to a pressure in the chamber. The first flow control element may be configured to open when the pressure is at a value determined for a first suspension performance; the second flow control element may be configured to open when the pressure is at a value determined for a second suspension performance; the third flow control element configured to open when the pressure is at a value to provide for a third suspension performance. The first flow control element may be configured to open when the pressure is at a value determined for a first suspension performance and to provide for a lockout condition; the second flow control element may be configured to open when the pressure is at a value determined for a second suspension performance less stiff than the first suspension performance; the third flow control element configured to open when the pressure is at a value to provide for a third suspension performance less stiff than the second suspension performance.

The system may comprise the first flow control element configured to open at a threshold value and the second flow control element configured to open at a threshold value and the third flow control element configured to open at a threshold value; when the first flow control element is open compression damping is provided in a lockout condition; when the second flow control element is open compression damping is provided at a firm performance; when the third flow control element is open compression damping is provided at a soft performance. The first flow control element is independent of the second flow control element; the first flow control element is independent of the third flow control element; the second flow control element is independent of the third flow control element.

Properties of compression damping may be determined by the first flow control element independent of properties of compression damping determined by the second flow control element; properties of compression damping may be determined by the first flow control element independent of properties of compression damping determined by the third flow control element; properties of compression damping may be determined by the second flow control element independent of properties of compression damping determined by the third flow control element; properties of compression damping may be set by the first flow control element independent of properties of compression damping set by the second flow control element; properties of compression damping may be set by the first flow control element independent of properties of compression damping set by the third flow control element; properties of compression damping may be set by the second flow control element independent of properties of compression damping set by the third flow control element; properties of compression damping may be may be provided by the first flow control element independent of properties of compression damping provided by the second flow control element; properties of compression damping may be provided by the first flow control element independent of properties of compression damping provided by the third flow control element; properties of compression damping may be provided by the second flow control element independent of properties of compression damping provided by the third flow control element; properties of compression damping may be set by the first flow control element independent of the second flow control element; properties of compression damping may be set by the first flow control element independent of the third flow control element; properties of compression damping may be set by the second flow control element independent of the third flow control element; properties of compression damping may be provided by the first flow control element independent of the second flow control element; properties of compression damping may be provided by the first flow control element independent of the third flow control element; properties of compression damping may be provided by the second flow control element independent of the third flow control element. The properties of compression damping may be provided by the first flow control element independent of the second flow control element; the properties of compression damping may be provided by the second flow control element independent of the third flow control element; and the properties of compression damping may be provided by the first flow control element independent of the third flow control element.

In the suspension system the first flow control element may be configured to open when the pressure is at a relatively higher threshold value and the second flow control element may be configured to open when the pressure is at a relatively intermediate threshold value and the third flow control element may be configured to open when the pressure is at a relatively lower threshold value.

In the suspension system the first flow control element may be configured to open when the pressure is at a relatively higher digressive threshold value; the second flow control element may be configured to open when the pressure is at a relatively lower digressive threshold value; the third flow control element may be configured to open when the pressure is at a progressive threshold value.

The system may comprise a control for a setting for compression damping; the setting may comprise a first setting for the first flow control element or a second setting for the second flow control element or a third setting for the third flow control element.

The system may comprise a control for a setting for compression damping; the setting may comprise a lockout setting for the first flow control element or a setting with the second flow control element set to open when the pressure is at the value determined for firm suspension performance or a setting with the third flow control element set to open when the pressure is at the value determined for soft suspension performance.

The system may comprise a control for a setting for compression damping; the setting may comprise a lockout setting with the first flow control element set to open when the pressure is at the value determined for the blowoff condition or a firm suspension setting with the second flow control element set to open when the pressure is at the value determined for firm suspension performance or a soft suspension setting with the third flow control element set to open when the pressure is at the value determined for soft suspension performance.

The system may be configured to operate in response to a stroke velocity and further comprising a fourth flow control element. The system may be configured to operate in response to a stroke velocity and further comprising a fourth flow control element configured to modify the pressure produced in the chamber by the stroke velocity.

In the suspension system a fourth flow control element may be configured to modify a bypass flow; the fourth flow control element may be configured to modify the bypass flow by modifying an area of an opening; the fourth flow control element may be configured to modify the bypass flow by modifying an area of an opening to modify the pressure produced by the stroke velocity; the fourth flow control element may be configured to modify the bypass flow by increasing the area of an opening to decrease the pressure produced by the stroke velocity; the fourth flow control element may be configured to modify the bypass flow by decreasing the area of an opening to increase the pressure produced by the stroke velocity; the fourth flow control element may be configured to modify the pressure produced by the stroke velocity for a bypass flow.

The adjuster may be configured to provide a range of adjustment for firm suspension performance at a firm suspension setting; the adjuster may be configured to provide a range of adjustment for soft suspension performance at a soft suspension setting; the adjuster may be configured to provide a range of adjustment for suspension performance at a setting of compression damping; the adjuster may be configured to provide a range of adjustment for firm suspension performance at the firm suspension setting and a range of adjustment for soft suspension performance at the soft suspension setting. The first flow control element may comprise a shim stack; the second flow control element may comprise a shim stack; the third flow control element may comprise a shim stack. The control configured to provide a setting for compression damping may comprise a knob; the adjuster configured to provide adjustment for bypass flow for compression damping may comprise a dial; the adjuster configured to provide adjustment for bypass flow for compression damping may comprise a dial co-located with the knob. A setting for compression damping at the control may comprise a lockout setting. The adjuster configured to adjust compression damping may be configured to actuate a needle. The adjustment range for compression damping may comprise an intermediate setting; the adjustment range for compression damping for high pressure may comprise an intermediate setting; the adjustment range for compression damping for high pressure is set at assembly of the suspension fork assembly; the adjustment range for compression damping for low pressure may comprise an intermediate setting; the adjustment range for compression damping for low pressure is set at assembly of the suspension fork assembly.

The present invention relates to a suspension system comprising a chamber and configured to provide for compression damping in response to a pressure in the chamber. The system may comprise a first flow control element configured to open when the pressure is at a first value and a second flow control element configured to open when the pressure is at a second value and a third flow control element configured to open when the pressure is at a third value. The system may comprise a control for a setting for compression damping; the setting may comprise a lockout setting with the first flow control element set to open when the pressure is at a value determined for a blowoff condition or a firm suspension setting with the second flow control element set to open when the pressure is at a value determined for firm suspension performance or a soft suspension setting with the third flow control element set to open when the pressure is at a value determined for soft suspension performance.

The system may comprise a control for a setting for compression damping; the setting may comprise a first suspension setting with the first flow control element set to open at the first pressure or a second suspension setting with the second flow control element set to open at the second pressure or a third suspension setting with the third flow control element set to open at the third pressure.

The value of the first pressure may comprise the value determined for the blowoff condition; the value of the second pressure may comprise the value determined for firm suspension performance; the value of the third pressure may comprise the value determined for soft suspension performance.

The system may be configured to operate in response to a stroke velocity and further comprising a fourth flow control element configured to modify the pressure produced in the chamber by the stroke velocity and an adjuster for the fourth flow control element. The system may be configured to operate in response to a stroke velocity and further comprising a fourth flow control element configured to modify the pressure produced in the chamber by the stroke velocity. The system may comprise an adjuster for the fourth flow control element. The system may comprise an adjuster configured to adjust the fourth flow control element. The adjuster may be configured to modify the pressure produced by the stroke velocity for a bypass flow. The adjuster for the fourth control element may be configured to modify the pressure produced by the stroke velocity for a bypass flow. The adjuster may be configured to provide a range of operation for suspension performance at a setting of compression damping.

The system may comprise a control configured to provide a setting for compression damping; the setting for compression damping may comprise a first setting of suspension performance and a second setting of suspension performance and a third setting of suspension performance; the setting for compression damping may comprise a setting for lockout and a setting for firm suspension performance and a setting soft suspension performance; the setting for compression damping may comprise independent settings comprising a setting for lockout and a setting for firm suspension performance and a setting soft suspension performance; the adjuster may be configured to provide a range of operation for firm suspension performance at the firm suspension setting; the adjuster may be configured to provide a range of operation for soft suspension performance at the soft suspension setting; the adjuster may be configured to provide a range of operation for firm suspension performance at the firm suspension setting and a range of operation for soft suspension performance at the soft suspension setting.

The range of operation for firm suspension performance at the firm suspension setting is independent of the range of operation for soft suspension performance at the soft suspension setting. The adjuster may be configured to provide a range of adjustment of operation for firm suspension performance at the firm suspension setting and a range of operation for soft suspension performance at the soft suspension setting. The first flow control element may be configured to operate at a setting to open when the pressure is at a value determined for a blowoff condition; the second flow control element configured to operate at a setting to open when the pressure is at a value determined for firm suspension performance (with a range of adjustment); the third flow control element may be configured to operate at a setting to open when the pressure is at a value determined for soft suspension performance (with a range of adjustment).

In the system each value of pressure may be independent; each setting may be independent; each setting may be selectable; each setting may be independently selectable; each setting may be independently selectable at the control; the control may be configured to provide each setting; the control may be configured to provide the first setting or the second setting or the third setting. A load may provide pressure in fluid in the chamber; the first value is greater than the second value, and the second value is greater than the third value; the first value, the second value, and the third value are independently selectable; the adjuster may be configured to operate a needle valve within the chamber. The flow control element configured to open flow for compression damping may comprise a needle valve. The flow control element configured to provide lockout of compression damping may comprise a valve. A setting for compression damping may comprise one of a setting for the first flow control element and a setting for the second flow control element and a setting for the third flow control element.

The first flow control element may comprise a shim stack; the second flow control element may comprise a shim stack; the third flow control element may comprise a shim stack; the first flow control element may comprise a shim stack separate from the second flow control element; the first flow control element may comprise a shim stack separate from the third flow control element; the second flow control element may comprise a shim stack separate from the third flow control element; the first flow control element may comprise a shim stack separate from the second flow control element and the second flow control element may comprise a shim stack separate from the third flow control element; the second flow control element may comprise a shim stack separate from the first flow control element; the third flow control element may comprise a shim stack separate from the first flow control element; the third flow control element may comprise a shim stack separate from the second flow control element; the first flow control element may comprise a shim stack independently selectable from the second flow control element; the first flow control element may comprise a shim stack independently selectable from the third flow control element; the second flow control element may comprise a shim stack independently selectable from the third flow control element.

The adjuster configured to set compression damping may be configured to provide an adjustment range for compression damping for high pressure and to provide an adjustment range for compression damping for low pressure; the adjuster may comprise a bypass adjuster configured to provide an adjustment range for compression damping for high pressure and to provide an adjustment range for compression damping for low pressure. The fourth flow control element may be configured to provide an adjustment range of bypass flow of compression damping for high pressure and to provide an adjustment range of bypass flow of compression damping for low pressure. The adjuster may be configured to adjust compression damping; the adjuster configured to adjust compression damping may be configured to adjust a needle; the adjuster configured to adjust compression damping may comprise a dial configured to adjust the needle; the adjuster configured to adjust compression damping may comprise a dial at a knob configured to adjust the needle; the adjuster configured to adjust compression damping may comprise a dial configured to adjust the needle; the adjuster may be configured to adjust bypass flow; the adjuster configured to adjust bypass flow may be configured to adjust a needle; the adjuster configured to adjust bypass flow may comprise a knob configured to adjust the needle; the adjuster configured to adjust bypass flow may comprise a dial configured to adjust the needle; the control configured to provide a setting for compression damping may comprise a knob; the adjuster may be co-located with the control; the adjuster may comprise a dial co-located with the control; the adjuster may comprise a dial co-located with a knob for the control; the adjuster configured to adjust bypass flow may be co-located with the control configured to provide a setting for compression damping.

### FIGURES

FIG. 1 is a schematic perspective view of a bicycle according to an exemplary embodiment.

FIGS. 2A and 2B are schematic perspective views of a suspension fork assembly according to an exemplary embodiment.

FIG. 3 is a schematic exploded perspective view of a suspension fork assembly according to an exemplary embodiment.

FIGS. 4 and 5 are schematic partial perspective views of a suspension fork assembly according to an exemplary embodiment.

FIG. 6 is a schematic partial perspective view of a suspension fork assembly according to an exemplary embodiment.

FIG. 7 is a schematic exploded perspective view of a suspension fork assembly according to an exemplary embodiment.

FIGS. 8A and 8B are schematic cross-section views of a compression assembly of a suspension fork assembly according to an exemplary embodiment.

FIGS. 9A through 9G are schematic cross-section views of a compression assembly of a suspension fork assembly according to an exemplary embodiment.

FIG. 10 is a schematic perspective view of component of a suspension fork assembly according to an exemplary embodiment.

FIG. 11 is a schematic perspective view of component of a suspension fork assembly according to an exemplary embodiment.

FIG. 12 is a schematic perspective view of component of a suspension fork assembly according to an exemplary embodiment.

FIG. 13 is a schematic perspective view of component of a suspension fork assembly according to an exemplary embodiment.

FIGS. 14A through 14D are schematic cutaway perspective views of a compression assembly of a suspension fork assembly according to an exemplary embodiment.

FIGS. 15A and 15B are schematic diagrams of compression damping/performance of a suspension fork assembly according to an exemplary embodiment.

FIG. 16 is a schematic diagram of compression damping/performance of a conventional suspension fork assembly.

### DESCRIPTION

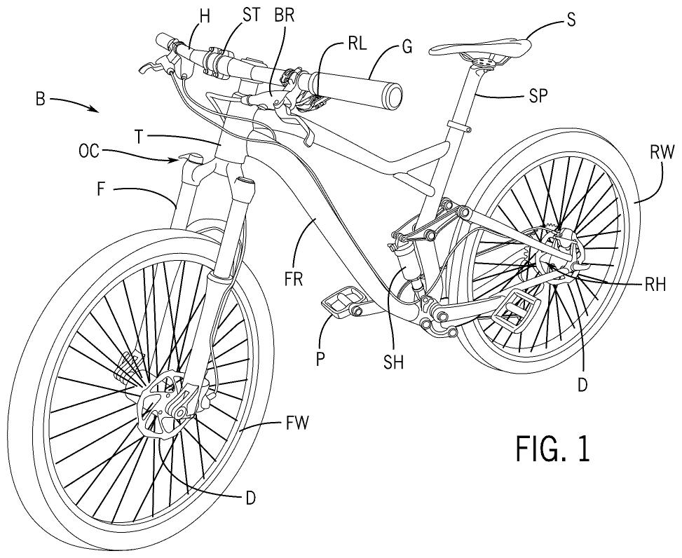

Referring to FIG. 1, a bicycle B is shown schematically according to an exemplary embodiment providing an arrangement of parts/components including a frame FR with a steering/head tube T and a seat post SP (with seat S) and a set of wheels comprising front wheel FW with a front fork/suspension assembly F and rear wheel RW with rear shock absorber SH coupled to the frame FR (through a suspension system) and a set of pedals P; the bicycle provides handlebar H (coupled to front wheel FW through stem ST and front fork assembly F and through head tube T) with an operator control (shown as a remote lever RL) and with operator control for a brake system BR coupled to a brake disc D (e.g. rotor at/on each of front wheel FW and rear wheel RW connected at rear hub RH) and a gear/shift control (coupled to a selectable gear system for rear wheel RW) and a grip G.

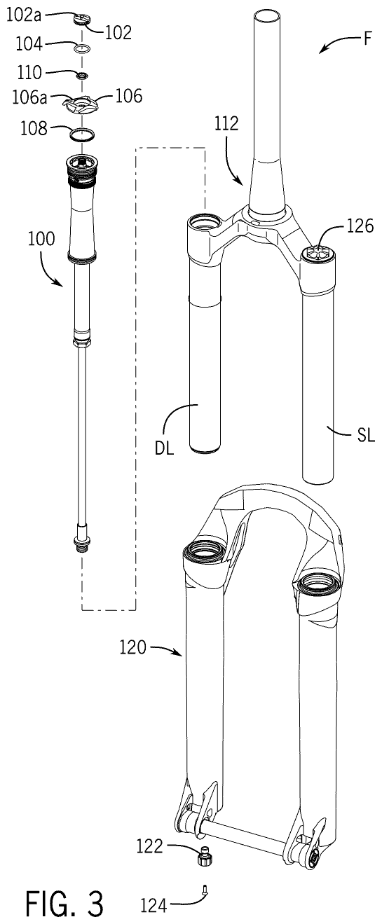

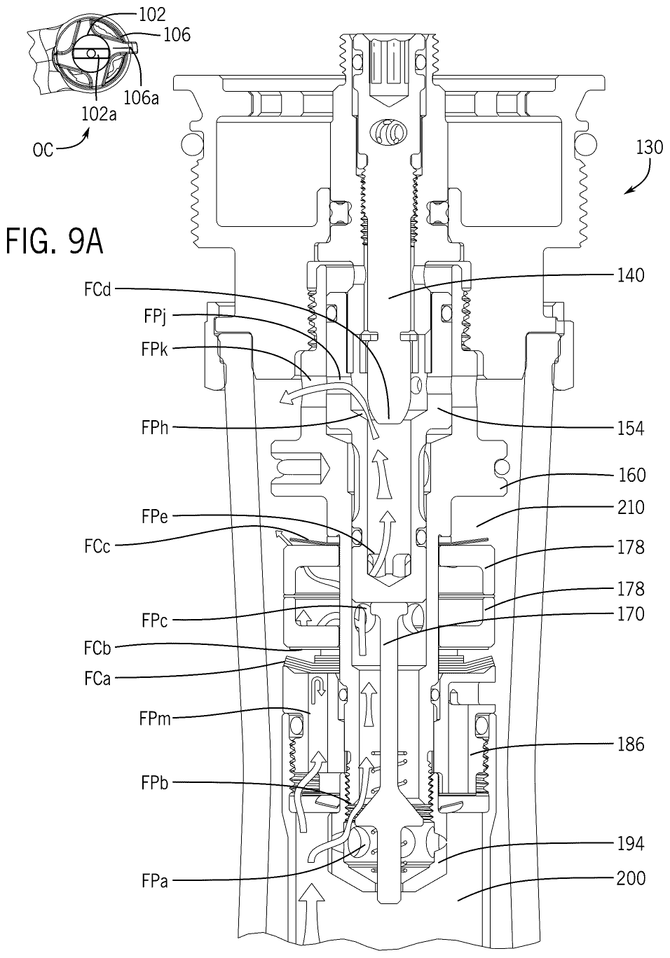

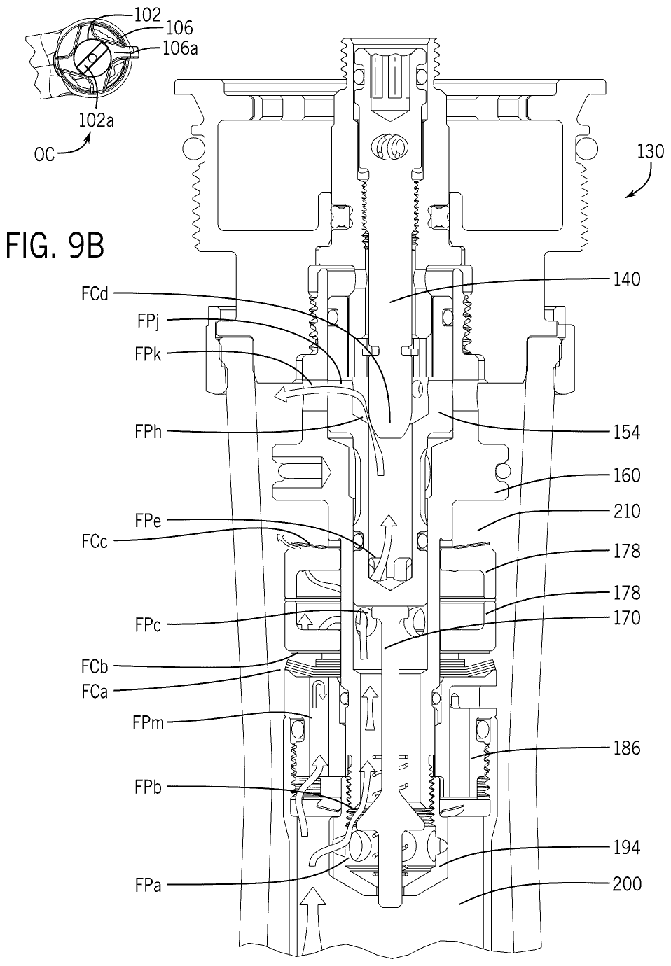

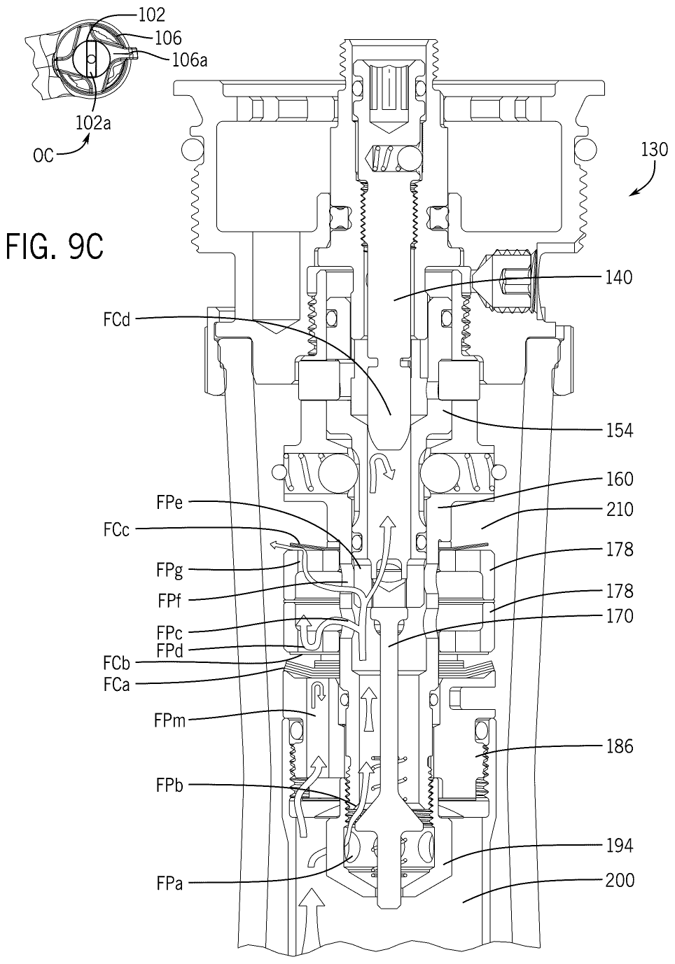

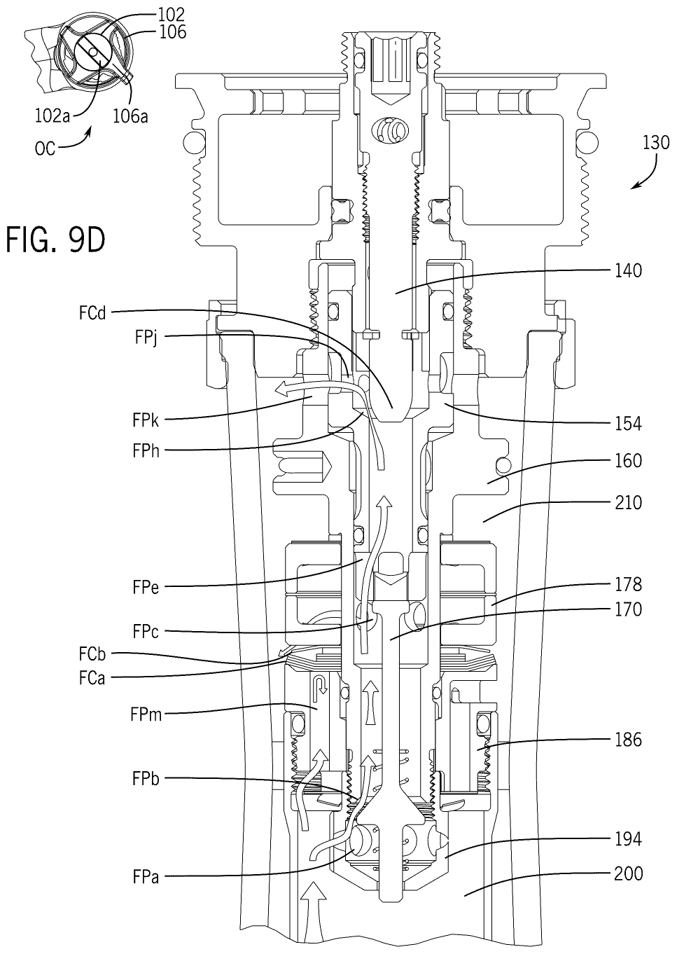

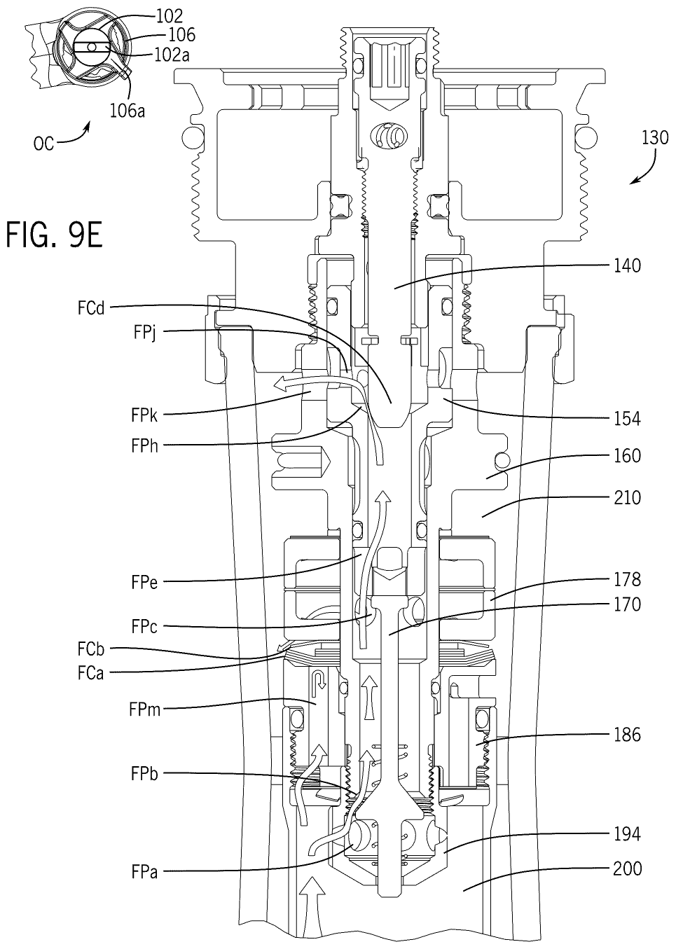

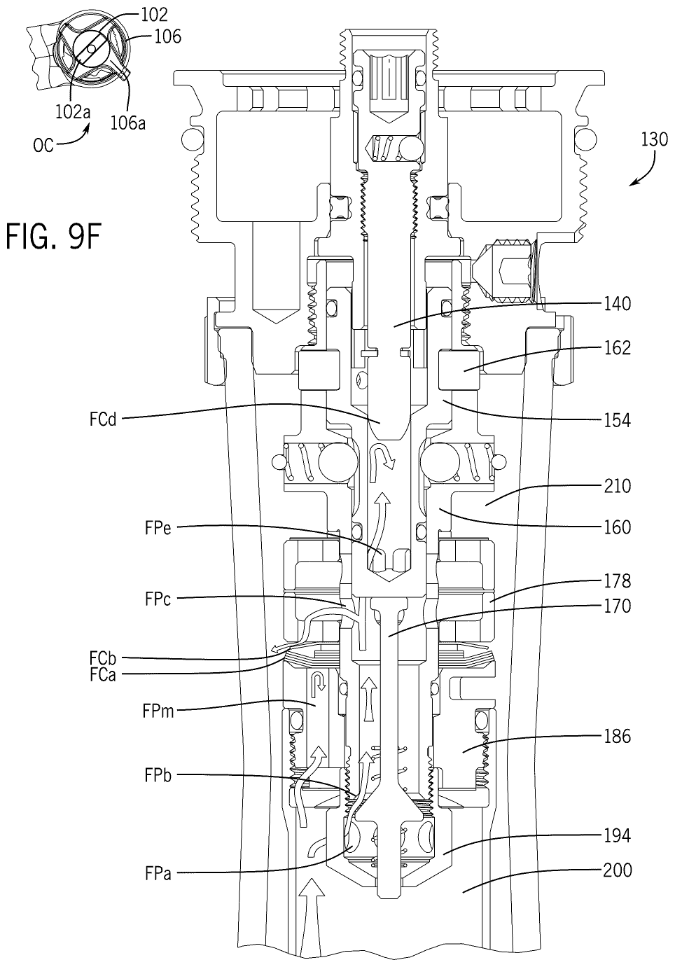

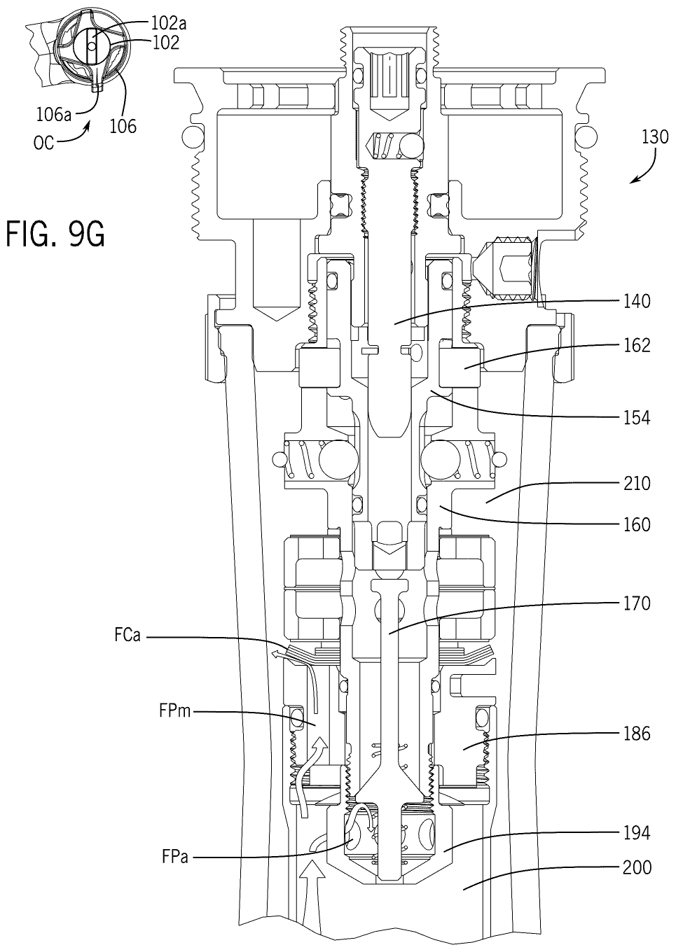

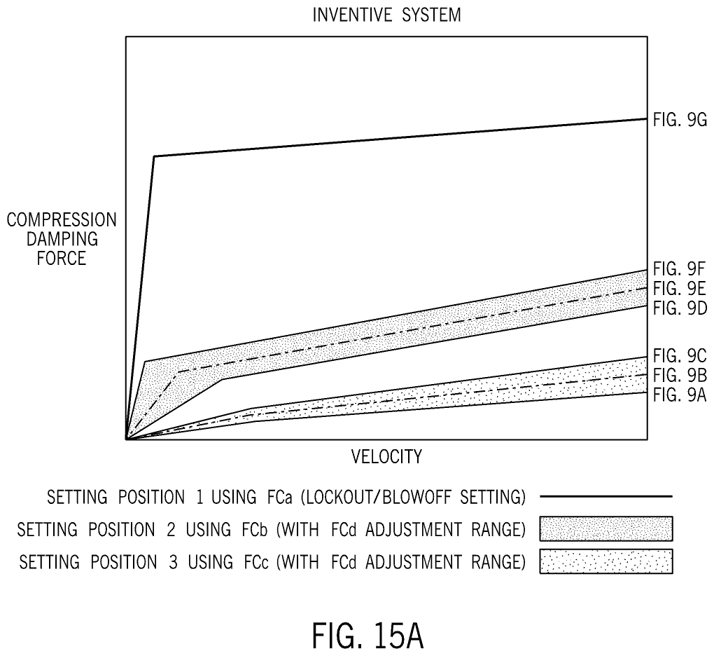

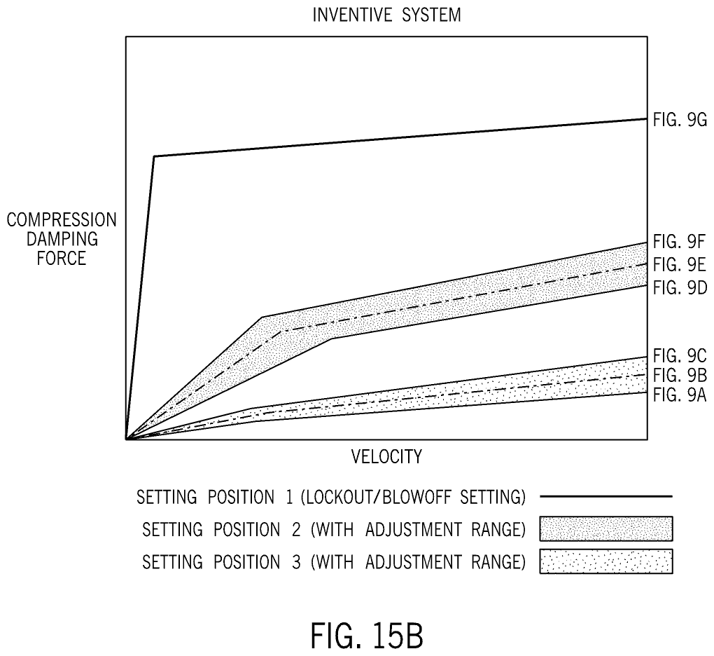

According to an exemplary embodiment as shown schematically in FIGS. 1, 2 and 3, a suspension system for bicycle B may comprise the suspension/fork assembly F (e.g. for the front fork of the bicycle) with a leg shown as spring leg SL and a leg shown as damper leg DL configured to provide suspension/compression damping for the bicycle B in operation; the suspension/fork assembly F also comprises an operator control OC shown as a dial/knob for setting and adjustment of suspension/compression damping. See also FIGS. 9A-9G and 15A-15B and TABLE A.

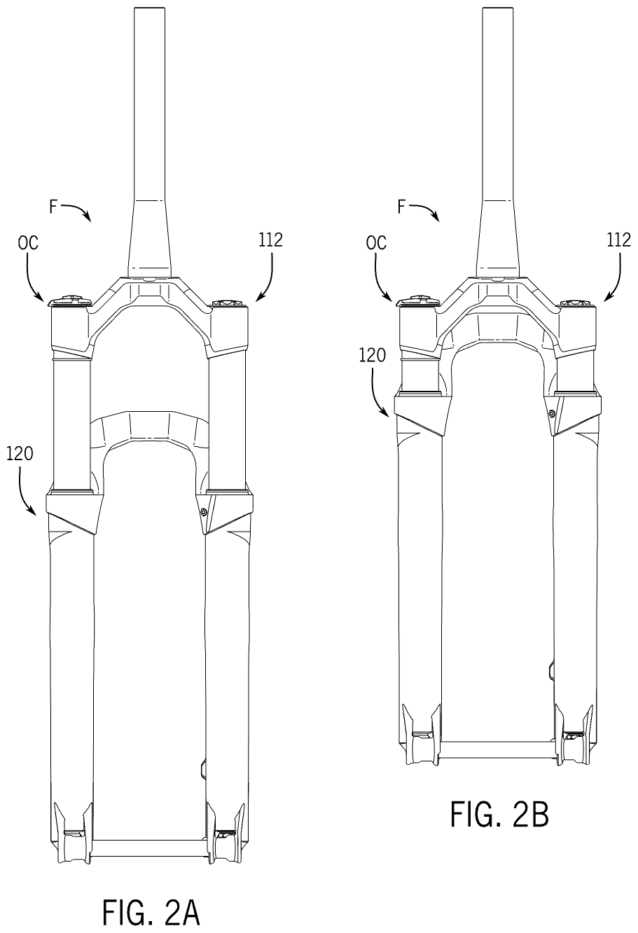

As indicated schematically in FIGS. 1, 2A and 2B, in operation when the suspension system with suspension fork assembly with damper assembly is in use to provide suspension/compression damping in response to an input (e.g. such as from an irregularity encountered by the front wheel) the suspension fork assembly F will be compressed/shortened as indicated in FIG. 2B; after the input, the fork assembly F will return to a default/extended condition (e.g. ready to encounter input to provide suspension/compression damping at the front wheel) as indicated in FIG. 2A.

As indicated schematically according to an exemplary embodiment in FIGS. 1, 2, 3, 8A-8B, 9A-9G, 14A-14D and 15A-15B, in operation the suspension fork assembly F provides a suspension system for the bicycle B; the damper assembly 100 of the suspension fork assembly F is configured to facilitate flow of hydraulic/suspension fluid (e.g. a contained volume of fluid) to provide suspension/compression damping between a default/extended condition (see FIG. 2A) and a compressed/shortened condition (see FIG. 2B) as the front wheel of the bicycle encounters irregularities (e.g. bumps, obstacles. holes, etc.); compression damping is provided according to a setting and adjustment at operator control OC. See also FIGS. 9A-9G and 15A-15B and TABLE A.

As indicated schematically in FIGS. 1, 2A-2B, 3, 9A-9G and 15A-15B, the suspension system for bicycle B with suspension fork assembly F with damper assembly 100 is configured to provide suspension/compression damping in use in response to an input based on a setting and/or adjustment at operator control OC. See also TABLE A. As indicated schematically in FIGS. 9A-9G and 15A-15B and TABLE A, the operator control OC is configured to provide a setting for compression damping and an adjustment for compression damping; as indicated schematically the setting at operator control OC for compression damping may comprise a lockout setting (FIG. 9G) or a first setting/position with adjustment (FIGS. 9A-9C) or a second setting/position with adjustment (FIGS. 9D-9F). As indicated schematically in FIGS. 9A-9G and 15A-15B and TABLE A, the suspension system with fork/damper assembly F/100 is configured so that each setting at operator control OC for compression damping is independent/independently selectable; the lockout setting (FIG. 9G) is independent of the first setting/position with adjustment (FIGS. 9A-9C) and is independent of the second setting/position with adjustment (FIGS. 9D-9F); the first setting/position is independent of the second setting/position.

As indicated schematically in FIGS. 1, 2A-2B, 3, 9A-9G and 15A-15B, the suspension system with suspension fork assembly F with damper assembly 100 is configured to provide a range of compression damping according to the setting/adjustment. As indicated schematically in FIGS. 15A-15B, in design of the suspension system, the fork/damper assembly F/100 may be configured to provide compression damping at the first setting/position to provide a first intended/desired performance independently and to provide compression damping at the second setting/position to provide a second intended/desired performance independently. Compare FIG. 15A and FIG. 15B.

As indicated schematically in FIGS. 1, 8A-8B, 9A-9G and 15A-15B, in design of the suspension system, the fork/damper assembly F/100 may be configured with flow control elements FC and to provide flow paths FP to provide for intended/desired performance of compression damping at each setting of operator control OC; for the first/lockout setting, flow control element FCa is actuated (see FIG. 9G); for the second setting of compression damping, flow control element FCb is actuated (see FIGS. 9D-9F); for the third setting of compression damping, flow control element FCc is actuated (see FIGS. 9A-9C); for adjustment of compression damping at the first/second setting within adjustment range, flow control element FCd is actuated (see FIGS. 9A-9F).

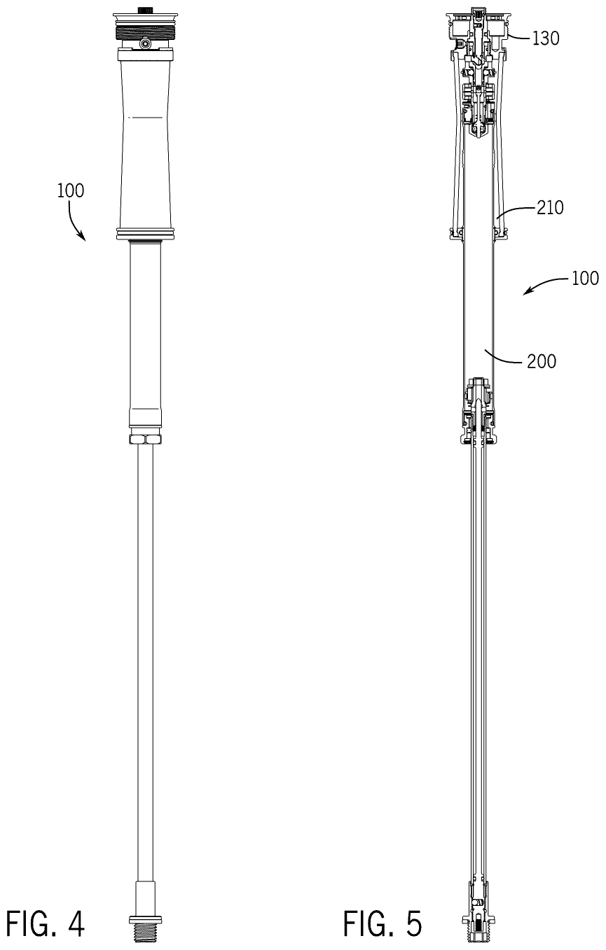

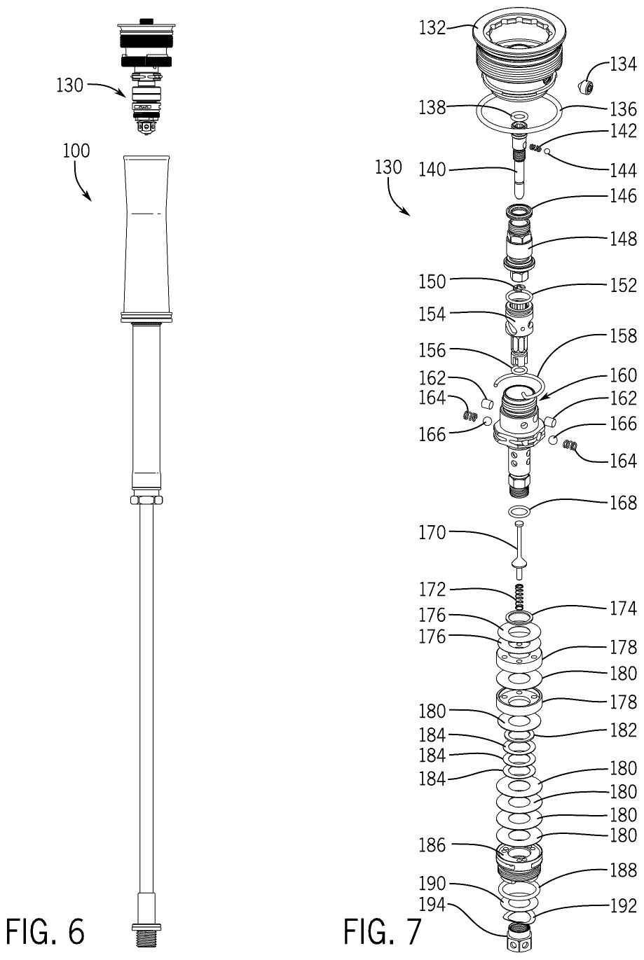

As indicated schematically in FIGS. 1, 2A-2B, 3, 4, 5, 6 and 9A-9G, selection of both setting/position and adjustment for performance for compression damping for the compression assembly 130 of fork/damper assembly F/100 is provided at operator control OC. As indicated schematically in FIGS. 1, 2A-2B, 3, 8A-8B, 9A-9G and 15A-15B, the operator control OC of the damper assembly 100 comprises a knob assembly 106/106a for selection of a setting for compression damping and a dial assembly 102/102a for adjustment of compression damping at a setting; the knob assembly 106/106a and dial assembly 102/102a are secured within the damper assembly 100 with a nut 110 and sealed with an O-ring 104 and seal 108. See also FIGS. 15A-15B and TABLE A. As indicated schematically in FIGS. 9A-9F and 15A-15B, in design of the flow control elements of the suspension system, the fork/damper assembly F/100 may be configured to provide an adjustment range for compression damping at the first setting/position to provide a first intended/desired performance within the range and to provide and adjustment range for compression damping at the second setting/position to provide a second intended/desired performance within the range. See also TABLE A.

As shown schematically according to an exemplary embodiment in FIGS. 2A-2B, 3, 4, 5, 6 and 7, the front suspension fork/damper assembly F/100 comprises the set of legs shown as spring leg SL with top cap 126 and damper leg DL with a compression assembly 130 and operator control OC; the front suspension fork/damper assembly F/100 comprises a lower assembly 120 movable (between a fully extended position and fully compressed position) within an upper assembly 112 comprising the operator control OC for compression damping at the compression assembly 130 and a first chamber 200 and the compression assembly 130 within a second chamber 210; spring leg SL is fit within lower assembly 120; damper leg DL is fit/retained within lower assembly 120 (with an adjuster knob 122 secured by screw 124).

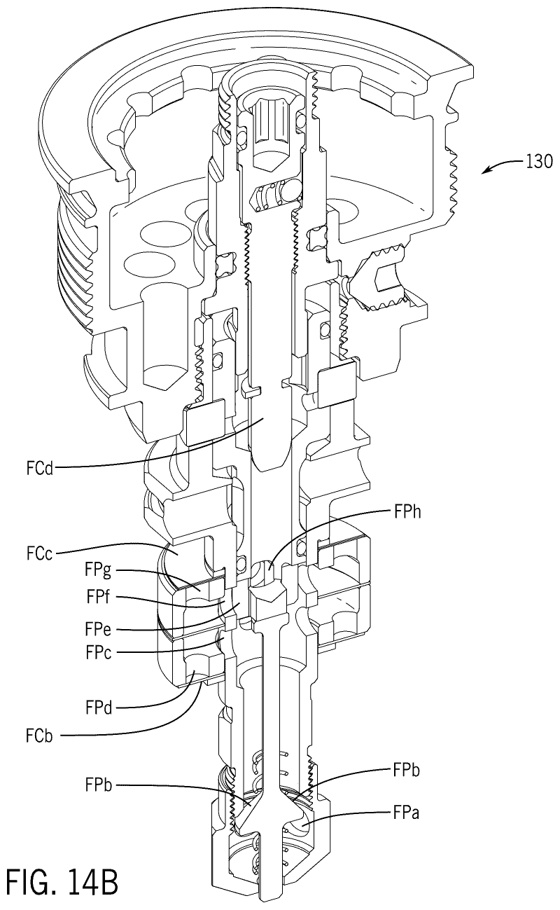

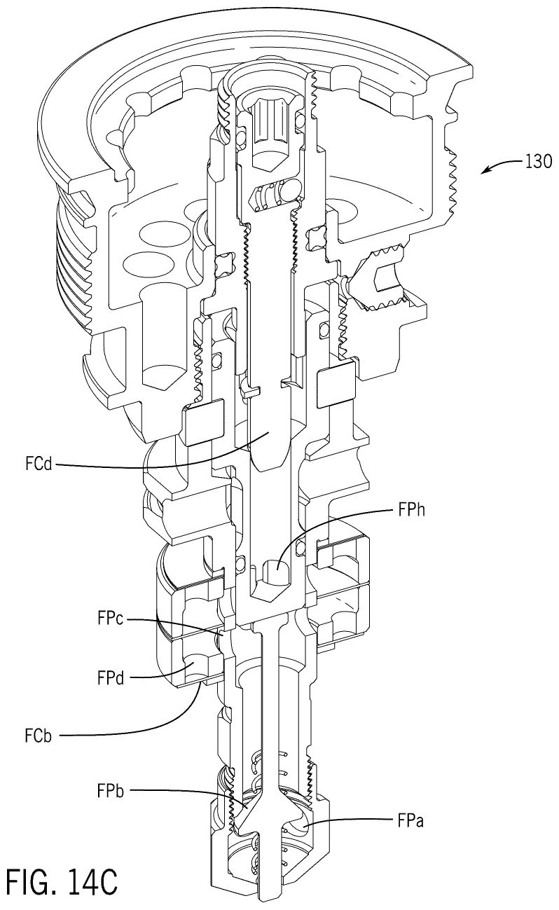

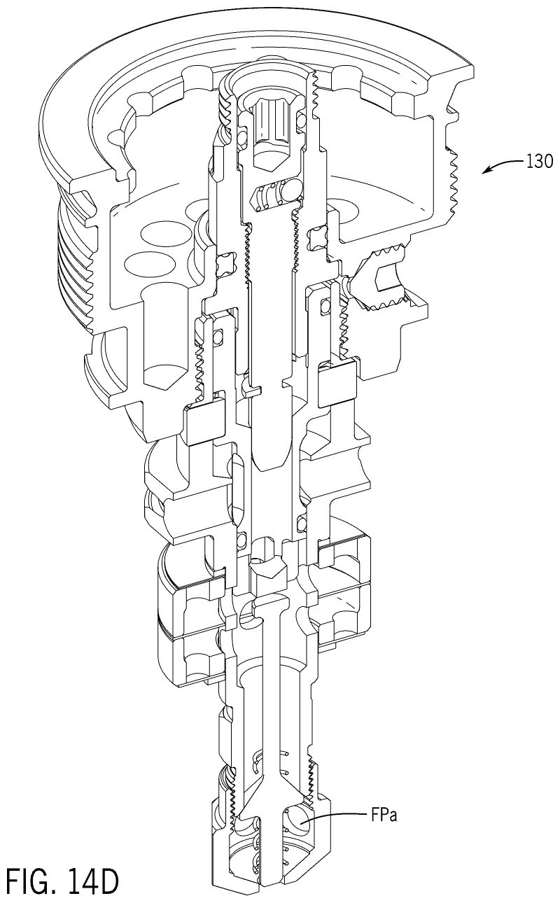

As shown schematically according to an exemplary embodiment in FIGS. 2A-2B, 3, 4, 5, 6, 7, 8A-8B, and 9A-9G, compression assembly 130 of suspension/damper assembly 100 within damper leg DL comprises a top cap 132 with an O-ring 136 and a bleed screw 134; compression assembly 130 comprises a needle 140 with tapered surface 140a with a spring 142 and ball 144 and seal 146 and O-ring 138 and retaining ring 150 to provide a flow control element FCd; needle 140 is configured for movement/adjustment by the dial 102 of the operator control OC; compression assembly 130 comprises a valve shaft 148 with O-ring 152 on a shaft shown as selector shaft 154 and O-ring 156 and a shaft shown as compression shaft 160 with pins 162 and springs 164 and balls 166 and retaining ring 158 with O-ring 168 and a poppet 170 with surface 170a with spring 172 to provide a flow control element/valve; selector shaft 154 is configured for movement/adjustment by the knob 106 of the operator control OC to actuate flow control elements of the compression assembly 130 of suspension/damper assembly 100; compression assembly 130 comprises a clamp shim 174 and shim/stack 176 at a piston cup 178 to provide a flow control element FCc and a shim 180 with clamp shim 182 at a piston cup 178 to provide a flow control element FCb and a shim/stack 184 with a shim/stack 180 at a piston 186 with O-ring 188 to provide a flow control element FCa; compression assembly 130 comprises a shim/stack 190 and a spring shim 192 with nut 194 with passage 194a to provide a flow control element/check valve. See also FIGS. 14A-14D.

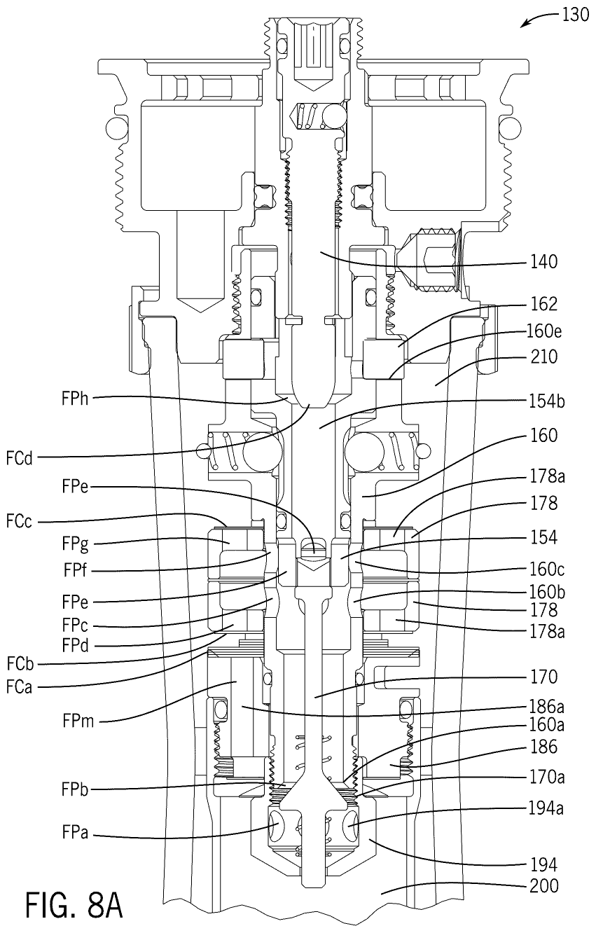

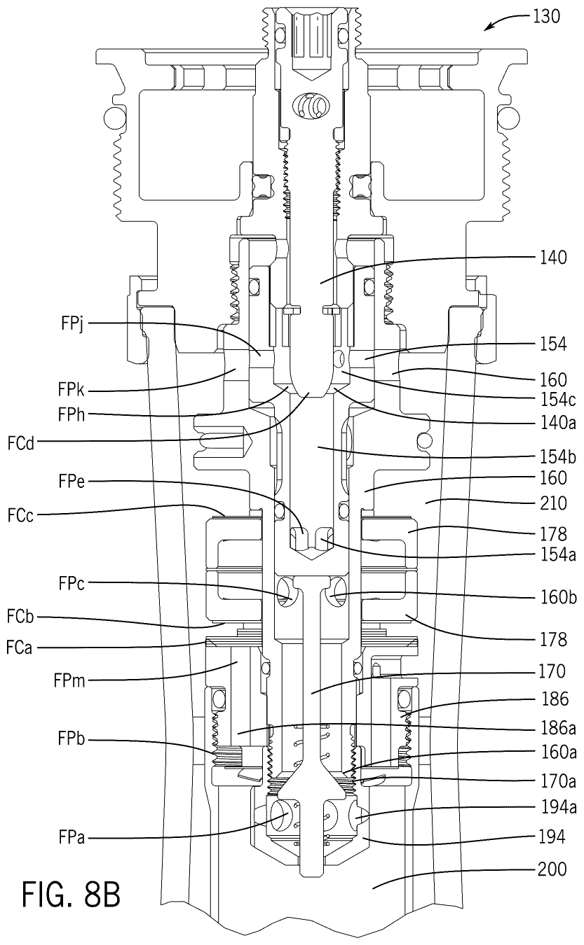

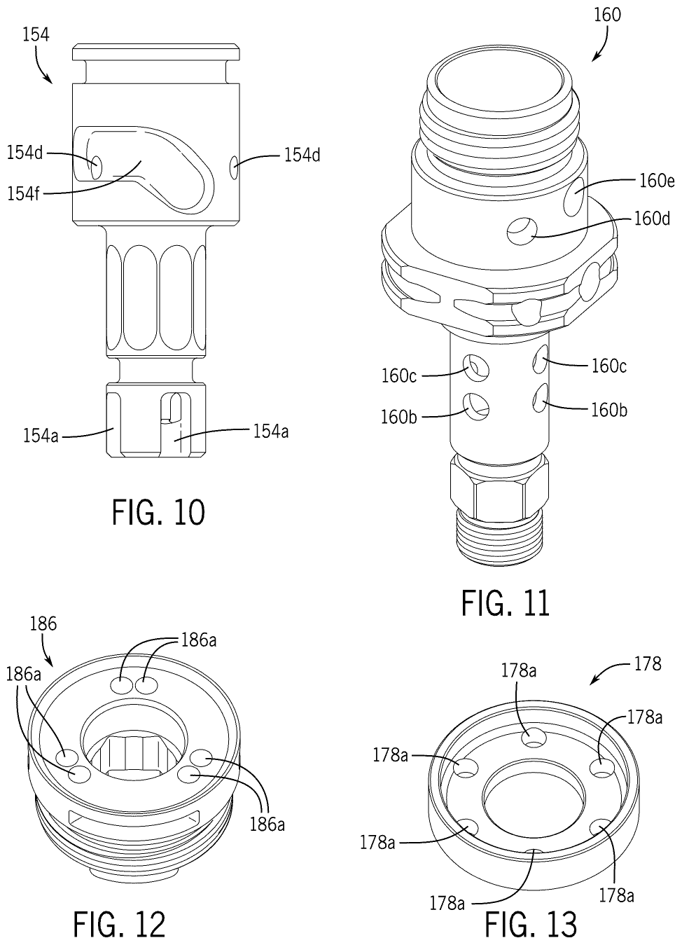

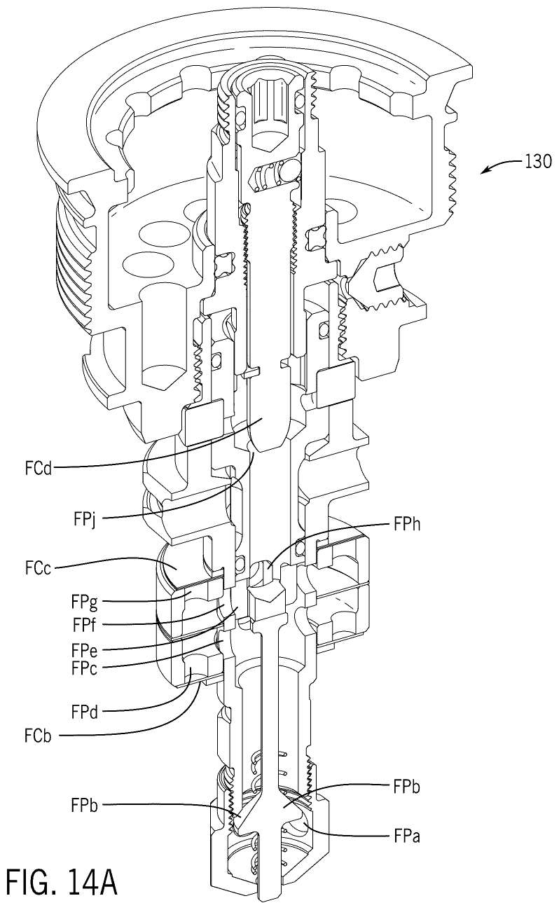

As indicated schematically in FIGS. 8A-8B, 9A-9G, 10, 11, 12, 13, 14A-14D and 15A-15B, the flow control arrangement for the compression/damper assembly 130 of the fork/suspension assembly 100 comprises the configuration of flow control elements FC and flow paths/passages FP. See also TABLES A and D. As indicated schematically in FIGS. 7, 8A and 10, shaft shown as selector shaft 154 comprise features such as passages 154a and 154b and 154c and a port 154d and cam slot 154f. As indicated schematically in FIGS. 7, 8A and 11, shaft shown as compression shaft 160 comprises features such as surface 160a and lower port 160b and upper port 160c and needle port 160d and hole 160e. As indicated schematically in FIGS. 7 and 12, piston 186 comprises features such as passages 186a. As indicated schematically in FIGS. 7 and 13, piston cup 178 comprises features such as ports 178a.

As indicated schematically in FIGS. 8A-8B, and 9A-9G, in design of the suspension system, the flow control elements FC of the suspension/damper assembly F/100 are configured to facilitate flow selectively through flow paths FP within and for the chamber to provide for intended/desired performance of compression damping during operation at each setting of operator control OC. See also FIGS. 15A-15B and TABLES D and E.

As indicated schematically in FIGS. 8A-8B, 9A-9G and 14A-14D and TABLES A and D, the fluid damper configuration (e.g. within chamber containing a hydraulic/suspension fluid) in the operation of the compression/damper assembly 130 comprises a state of compression for assembly under an input load (e.g. light, heavy) and state of rebound after the input load; setting of compression/damper assembly 130 for operation comprises selection of a flow control element FCa/FCb/FCc and adjustment of a flow control element FCd between an open state and a closed state to configure flow paths/passages for fluid flow at the compression/damper assembly 130; the compression damper assembly 130 may comprise passages for fluid flow shown as passages FPa/FPb/FPc/FPd/FPe/FPf/FPg/FPh/FPj/FPk/FPm. As indicated schematically in FIGS. 8A-8B, 9A-9G and 14A-14D, the flow control arrangement for the compression/damper assembly 130 of the fork/suspension assembly 100 comprises the combination of flow control elements and flow paths/passages to provide compression damping/performance. See also FIGS. 15A-15B and TABLE A.

### Operation—Settings/Adjustment

As indicated schematically in FIGS. 1, 2A-2B, 3, 8A-8B, 9A-9G, 14A-14D and 15A-15B, the suspension system with suspension fork assembly F with damper assembly 100 with compression assembly 130 is configured to provide a range of compression damping according to the setting/adjustment. See also TABLES A through D.

TABLE A

| | | | | | | | | | | | | FLOW CONTROL | | | |
|---|---|---|---|---|---|---|---|---|---|---|---|---|---|---|---|
| | FLOW PATH | | | | | | | | | | | ELEMENT | | | |
| FIG | FPa | FPb | FPc | FPd | FPe | FPf | FPg | FPh | FPj | FPk | FPm | FCa | FCb | FCc | FCd |
| 9A | o | o | − | − | o | o | o | o | o | o | − | − | − | o− | o |
| 14A | | | | | | | | | | | | | | | |
| 9B | o | o | − | − | o | o | o | (o) | o | o | − | − | − | o− | (o) |
| 9C | o | o | − | − | o | o | o | x | − | − | − | − | − | o− | x |
| 14B | | | | | | | | | | | | | | | |
| 9D | o | o | o | o | − | x | − | o | o | o | − | − | o − i | − | o |
| 9E | o | o | o | o | o | x | − | (o) | − | − | − | − | o − i | − | o |
| 9F | o | o | o | o | − | x | − | x | − | − | − | − | o − i | − | o |
| 14C | | | | | | | | | | | | | | | |
| 9G | o | x | − | − | − | − | − | − | − | − | o | o+ | − | − | − |
| 14D | | | | | | | | | | | | | | | |

TABLE A-1
FLOW PATH

| | |
|---|---|
| ∘ | Open (by setting) |
| (∘) | Partially open (by setting/adjustment) |
| x | Closed (by setting) |
| — | Not relevant. |

TABLE A-2
FLOW CONTROL ELEMENT

| | |
|---|---|
| ∘ | Open (by setting) |
| ∘+ | Open (by setting/adjustment) - High pressure |
| ∘ − i | Open (by setting/adjustment) - intermediate pressure |
| ∘− | Open (by setting/adjustment) - low pressure |
| x | Closed (by setting) |
| — | Not relevant. |

As indicated schematically in FIGS. 9A-9F and TABLE A, the fork/damper assembly is configured to provide independent settings for compression damping at each of the first setting/position/lockout and the second setting/position and the third setting/position.

As indicated schematically in FIG. 9G and TABLE A, the fork/damper assembly F/100 may be configured to provide a first/lockout setting/position through flow control element FCa through flow path FPm by selection of setting at operator control OC to provide intended/desired performance (e.g. lockout of compression damping until sufficient input force for blowoff). See also FIGS. 14D and 15A-15B.

As indicated schematically in FIGS. 9D-9F and TABLE A, the fork/damper assembly F/100 may be configured to provide compression damping at the second setting/position through flow control element FCb by selection of setting/adjustment at operator control OC to provide a second intended/desired performance with adjustment at flow control element FCd; if unrestricted by adjustment at flow control element FCd (FIG. 9D) the flow is provided through flow paths FPa/FPb/FPc/FPd/FPe/FPh/FPj/FPk; if partially restricted by adjustment at flow control element FCd (FIG. 9E) the flow is provided through flow paths FPa/FPb/FPc/FPd/FPe/FPh/FPj/FPk with restriction at flow path FPh; if restricted by adjustment at flow control element FCd (FIG. 9F) the flow is provide through flow paths FPa/FPb/FPc/FPd. See also FIGS. 8A-8B, 14C and 15A-15B.

As indicated schematically in FIGS. 9A-9C and TABLE A, the fork/damper assembly F/100 may be configured to provide compression damping at the third setting/position through flow control element FCc by selection of setting/adjustment at operator control OC to provide a first intended/desired performance with adjustment at flow control element FCd; if unrestricted by adjustment at flow control element FCd (FIG. 9A) the flow is provided through flow paths FPa/FPb/FPe/FPf/FPg/FPh/FPj/FPk; if partially restricted by adjustment at flow control element FCd (FIG. 9B) the flow is provided through flow paths FPa/FPb/FPe/FPf/FPg/FPh/FPj/FPk with restriction at flow path FPh; if restricted by adjustment at flow control element FCd (FIG. 9C) the flow is provide through flow paths FPa/FPb/FPf/FPg. See also FIGS. 8A-8B, 14A-14B and 15A-15B.

As indicated schematically in FIG. 1 and TABLE A, in operation the suspension fork assembly F for the suspension system for the bicycle B will encounter a variety of types of input loads, such as very light/slight, light, heavy, etc.; the suspension fork assembly F with compression/damper assembly 130 is configured by design and with and independent setting/adjustment of flow control elements (e.g. needle position, shim elements, etc.) to provide efficient and effective suspension damping/response for each of a variety of types of input loads.

As indicated schematically in FIGS. 9A-9G and TABLE A/A-1/A-2, flow control elements and flow paths/passages may be open (by setting), partially open (by setting/adjustment), closed (by setting), or not relevant (not accessible to flow or not utilized for flow due to insufficient pressure).

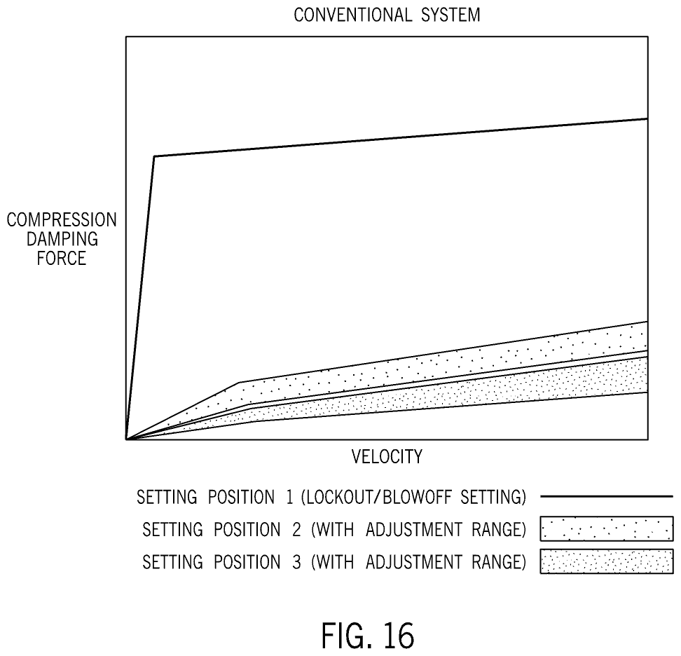

As indicated schematically in FIG. 16, a conventional system may provide for compression damping with a first flow control element and a second flow control element with two settings.

According to an exemplary embodiment shown schematically in FIGS. 1, 2A-2B, 3, 8A-8B, 9A-9G and 15A-15B, an improved suspension fork assembly configured to provide for compression damping may comprise a first flow control element configured for operation at an independent first setting of compression damping and a second flow control element configured for operation at an independent second setting of compression damping and a third flow control element configured to operation at an independent third setting of compression damping

### Exemplary Embodiments—A

According to an exemplary embodiment shown schematically in FIGS. 1, 2A-2B, 3, 8A-8B, 9A-9G and 15A-15B, a suspension system may be configured to provide for compression damping; the system may comprise a first flow control element FCa configured for operation at a first setting of compression damping and a second flow control element FCb configured for operation at a second setting of compression damping and a third flow control element FCc configured to operation at a third setting of compression damping; the first setting is independent of the second setting and the third setting; the second setting is independent of the first setting and third setting; the third setting is independent of the first setting and the second setting.

According to an exemplary embodiment shown schematically in FIGS. 8A-8B, 9A-9G and 15A-15B, the first flow control element is independent of the second flow control element and the third flow control element; the second flow control element is independent of the first flow control element and the third flow control element; the third flow control element is independent of the first flow control element and the second flow control element. The first setting is selectable independent of the second setting and the third setting; the second setting is selectable independent of the first setting and third setting; the third setting is selectable independent of the first setting and the second setting. Compression damping at the first setting is selectable independent of the second setting and the third setting; compression damping at the second setting is selectable independent of the first setting and third setting; compression damping at the third setting is selectable independent of the first setting and the second setting.

According to an exemplary embodiment shown schematically in FIGS. 1, 2A-2B, 3, 8A-8B and 9A-9G, the system may comprise a chamber configured to provide for compression damping in response to a pressure in the chamber. The first flow control element FCa may be configured to open when the pressure is at a value determined for a first suspension performance; the second flow control element FCb may be configured to open when the pressure is at a value determined for a second suspension performance; the third flow control element FCd configured to open when the pressure is at a value to provide for a third suspension performance. The first flow control element FCa may be configured to open when the pressure is at a value determined for a first suspension performance and to provide for a lockout condition; the second flow control element FCb may be configured to open when the pressure is at a value determined for a second suspension performance less stiff than the first suspension performance; the third flow control element FCc may be configured to open when the pressure is at a value to provide for a third suspension performance less stiff than the second suspension performance.

According to an exemplary embodiment shown schematically in FIGS. 1, 2A-2B, 3, 8A-8B, 9A-9G and 15A-15B, the suspension system may comprise the first flow control element FCa and the second flow control element FCb and the third flow control element FCc, the first flow control element FCa may be configured to open at a threshold value and the second flow control element FCb may be configured to open at a threshold value and the third flow control element FCc may be configured to open at a threshold value; when the first flow control element is open compression damping is provided in a lockout condition; when the second flow control element is open compression damping is provided at a firm performance; when the third flow control element is open compression damping is provided at a soft performance. The first flow control element is independent of the second flow control element; the first flow control element is independent of the third flow control element; the second flow control element is independent of the third flow control element.

According to an exemplary embodiment shown schematically in FIGS. 1, 2A-2B, 3, 8A-8B, 9A-9G and 15A-15B, properties of compression damping may be determined by the first flow control element independent of properties of compression damping determined by the second flow control element; properties of compression damping may be determined by the first flow control element independent of properties of compression damping determined by the third flow control element; properties of compression damping may be determined by the second flow control element independent of properties of compression damping determined by the third flow control element; properties of compression damping may be set by the first flow control element independent of properties of compression damping set by the second flow control element; properties of compression damping may be set by the first flow control element independent of properties of compression damping set by the third flow control element; properties of compression damping may be set by the second flow control element independent of properties of compression damping set by the third flow control element; properties of compression damping may be may be provided by the first flow control element independent of properties of compression damping provided by the second flow control element; properties of compression damping may be provided by the first flow control element independent of properties of compression damping provided by the third flow control element; properties of compression damping may be provided by the second flow control element independent of properties of compression damping provided by the third flow control element; properties of compression damping may be set by the first flow control element independent of the second flow control element; properties of compression damping may be set by the first flow control element independent of the third flow control element; properties of compression damping may be set by the second flow control element independent of the third flow control element; properties of compression damping may be provided by the first flow control element independent of the second flow control element: properties of compression damping may be provided by the first flow control element independent of the third flow control element; properties of compression damping may be provided by the second flow control element independent of the third flow control element. The properties of compression damping may be provided by the first flow control element independent of the second flow control element; the properties of compression damping may be provided by the second flow control element independent of the third flow control element; and the properties of compression damping may be provided by the first flow control element independent of the third flow control element.

According to an exemplary embodiment shown schematically in FIGS. 1, 2A-2B, 3, 8A-8B, 9A-9G and 15A-15B, in the suspension system the first flow control element FCa may be configured to open when the pressure is at a relatively higher threshold value and the second flow control element FCb may be configured to open when the pressure is at a relatively intermediate threshold value and the third flow control element FCc may be configured to open when the pressure is at a relatively lower threshold value.

According to an exemplary embodiment shown schematically in FIGS. 1, 2A-2B, 3, 8A-8B, 9A-9G and 15A-15B, in the suspension system the first flow control element FCa may be configured to open when the pressure is at a relatively higher digressive threshold value; the second flow control element FCb may be configured to open when the pressure is at a relatively lower digressive threshold value; the third flow control element FCc may be configured to open when the pressure is at a progressive threshold value.

The system may comprise a control for a setting for compression damping; the system may comprise a control for a setting for compression damping; the setting may comprise a first setting for the first flow control element FCa or a second setting for the second flow control element FCb or a third setting for the third flow control element FCc.

According to an exemplary embodiment shown schematically in FIGS. 1, 2A-2B, 3, 8A-8B and 9A-9G, the system may comprise a control for a setting for compression damping; the setting may comprise a lockout setting for the first flow control element FCa or a setting with the second flow control element FCb set to open when the pressure is at the value determined for firm suspension performance or a setting with the third flow control element FCc set to open when the pressure is at the value determined for soft suspension performance.

According to an exemplary embodiment shown schematically in FIGS. 1, 2A-2B, 3, 8A-8B and 9A-9G, the system may comprise a control for a setting for compression damping; the setting may comprise a lockout setting with the first flow control element FCa set to open when the pressure is at the value determined for the blowoff condition or a firm suspension setting with the second flow control element FCb set to open when the pressure is at the value determined for firm suspension performance or a soft suspension setting with the third flow control element FCc set to open when the pressure is at the value determined for soft suspension performance.

According to an exemplary embodiment shown schematically in FIGS. 1, 2A-2B, 3, 8A-8B and 9A-9G, the system may be configured to operate in response to a stroke velocity and further may comprise a fourth flow control element FCd. The system may be configured to operate in response to a stroke velocity and further comprising a fourth flow control element FCd configured to modify the pressure produced in the chamber by the stroke velocity.

According to an exemplary embodiment shown schematically in FIGS. 1, 2A-2B, 3, 8A-8B, 9A-9G and 15A-15B, in the suspension system a fourth flow control element FCd may be configured to modify a bypass flow; the fourth flow control element FCd may be configured to modify the bypass flow by modifying an area of an opening; the fourth flow control element FCd may be configured to modify the bypass flow by modifying an area of an opening to modify the pressure produced by the stroke velocity; the fourth flow control element FCd may be configured to modify the bypass flow by increasing the area of an opening to decrease the pressure produced by the stroke velocity; the fourth flow control element FCd may be configured to modify the bypass flow by decreasing the area of an opening to increase the pressure produced by the stroke velocity; the fourth flow control element FCd may be configured to modify the pressure produced by the stroke velocity for a bypass flow.

According to an exemplary embodiment shown schematically in FIGS. 1, 2A-2B, 3, 8A-8B, 9A-9G and 15A-15B, the adjuster may be configured to provide a range of adjustment for firm suspension performance at a firm suspension setting; the adjuster may be configured to provide a range of adjustment for soft suspension performance at a soft suspension setting; the adjuster may be configured to provide a range of adjustment for suspension performance at a setting of compression damping; the adjuster may be configured to provide a range of adjustment for firm suspension performance at the firm suspension setting and a range of adjustment for soft suspension performance at the soft suspension setting.

According to an exemplary embodiment shown schematically in FIGS. 1, 2A-2B, 3, 8A-8B, 9A-9G and 15A-15B, the first flow control element may comprise a shim stack; the second flow control element may comprise a shim stack; the third flow control element may comprise a shim stack. The control configured to provide a setting for compression damping may comprise a knob; the adjuster configured to provide adjustment for bypass flow for compression damping may comprise a dial; the adjuster configured to provide adjustment for bypass flow for compression damping may comprise a dial co-located with the knob. A setting for compression damping at the control may comprise a lockout setting. The adjuster configured to adjust compression damping may be configured to actuate a needle. The adjustment range for compression damping may comprise an intermediate setting; the adjustment range for compression damping for high pressure may comprise an intermediate setting; the adjustment range for compression damping for high pressure is set at assembly of the suspension fork assembly.

According to an exemplary embodiment shown schematically in FIGS. 1, 2A-2B, 3, 8A-8B, 9A-9G and 15A-15B, a suspension system comprising a chamber may be configured to provide for compression damping in response to a pressure in the chamber. The system may comprise a first flow control element FCa configured to open when the pressure is at a first value and a second flow control element FCb configured to open when the pressure is at a second value and a third flow control element FCc configured to open when the pressure is at a third value. The system may comprise a control for a setting for compression damping; the setting may comprise a lockout setting with the first flow control element FCa set to open when the pressure is at a value determined for a blowoff condition or a firm suspension setting with the second flow control element FCb set to open when the pressure is at a value determined for firm suspension performance or a soft suspension setting with the third flow control element FCc set to open when the pressure is at a value determined for soft suspension performance.

According to an exemplary embodiment shown schematically in FIGS. 1, 2A-2B, 3, 8A-8B and 9A-9G, the system may comprise a control for a setting for compression damping; the setting may comprise a first suspension setting with the first flow control element FCa set to open at the first pressure or a second suspension setting with the second flow control element FCb set to open at the second pressure or a third suspension setting with the third flow control element FCc set to open at the third pressure. The value of the first pressure may comprise the value determined for the blowoff condition; the value of the second pressure may comprise the value determined for firm suspension performance; the value of the third pressure may comprise the value determined for soft suspension performance.

According to an exemplary embodiment shown schematically in FIGS. 1, 2A-2B, 3, 8A-8B and 9A-9G, the system may be configured to operate in response to a stroke velocity and further comprising a fourth flow control element FCd configured to modify the pressure produced in the chamber by the stroke velocity and an adjuster for the fourth flow control element. The system may be configured to operate in response to a stroke velocity and further comprising a fourth flow control element FCd configured to modify the pressure produced in the chamber by the stroke velocity. The system may comprise an adjuster for the fourth flow control element. The system may comprise an adjuster configured to adjust the fourth flow control element. The adjuster may be configured to modify the pressure produced by the stroke velocity for a bypass flow. The adjuster for the fourth control element may be configured to modify the pressure produced by the stroke velocity for a bypass flow. The adjuster may be configured to provide a range of operation for suspension performance at a setting of compression damping.

According to an exemplary embodiment shown schematically in FIGS. 1, 2A-2B, 3, 8A-8B and 9A-9G, the system may comprise a control configured to provide a setting for compression damping; the setting for compression damping may comprise a first setting of suspension performance and a second setting of suspension performance and a third setting of suspension performance; the setting for compression damping may comprise a setting for lockout and a setting for firm suspension performance and a setting soft suspension performance; the setting for compression damping may comprise independent settings comprising a setting for lockout and a setting for firm suspension performance and a setting soft suspension performance; the adjuster may be configured to provide a range of operation for firm suspension performance at the firm suspension setting; the adjuster may be configured to provide a range of operation for soft suspension performance at the soft suspension setting; the adjuster may be configured to provide a range of operation for firm suspension performance at the firm suspension setting and a range of operation for soft suspension performance at the soft suspension setting.

According to an exemplary embodiment shown schematically in FIGS. 1, 2A-2B, 3, 8A-8B and 9A-9G, the range of operation for firm suspension performance at the firm suspension setting may be independent of the range of operation for soft suspension performance at the soft suspension setting. The adjuster may be configured to provide a range of adjustment of operation for firm suspension performance at the firm suspension setting and a range of operation for soft suspension performance at the soft suspension setting.

According to an exemplary embodiment shown schematically in FIGS. 1, 2A-2B, 3, 8A-8B and 9A-9G, the first flow control element FCa may be configured to operate at a setting to open when the pressure is at a value determined for a blowoff condition; the second flow control element FCb configured to operate at a setting and with the adjuster to open when the pressure is at a value determined for firm suspension performance; the third flow control element FCc may be configured to operate at a setting and with the adjuster to open when the pressure is at a value determined for soft suspension performance.

According to an exemplary embodiment shown schematically in FIGS. 1, 2A-2B, 3, 8A-8B, 9A-9G and 15A-15B, in the suspension system each value of pressure may be independent; each setting may be independent; each setting may be selectable; each setting may be independently selectable; each setting may be independently selectable at the control; the control may be configured to provide each setting; the control may be configured to provide the first setting or the second setting or the third setting. A load may provide pressure in fluid in the chamber; the first value is greater than the second value, and the second value is greater than the third value; the first value, the second value, and the third value are independently selectable; the adjuster may be configured to operate a needle valve within the chamber. The flow control element (FCd) configured to open flow for compression damping may comprise a needle valve. The flow control element (FCa) configured to provide lockout of compression damping may comprise a valve.

According to an exemplary embodiment shown schematically in FIGS. 1, 2A-2B, 3, 8A-8B and 9A-9G, a setting for compression damping may comprise one of a setting for the first flow control element and a setting at the second flow control element and a setting at the third flow control element.

According to an exemplary embodiment shown schematically in FIGS. 1, 2A-2B, 3, 8A-8B and 9A-9G, the first flow control element may comprise a shim stack; the second flow control element may comprise a shim stack; the third flow control element may comprise a shim stack; the first flow control element may comprise a shim stack separate from the second flow control element; the first flow control element may comprise a shim stack separate from the third flow control element; the second flow control element may comprise a shim stack separate from the third flow control element; the first flow control element may comprise a shim stack separate from the second flow control element and the second flow control element may comprise a shim stack separate from the third flow control element; the second flow control element may comprise a shim stack separate from the first flow control element; the third flow control element may comprise a shim stack separate from the first flow control element; the third flow control element may comprise a shim stack separate from the second flow control element; the first flow control element may comprise a shim stack independently selectable from the second flow control element; the first flow control element may comprise a shim stack independently selectable from the third flow control element; the second flow control element may comprise a shim stack independently selectable from the third flow control element.

According to an exemplary embodiment shown schematically in FIGS. 1, 2A-2B, 3, 8A-8B and 9A-9G, the adjuster configured to set compression damping may be configured to provide an adjustment range for compression damping for high pressure and to provide an adjustment range for compression damping for low pressure; the adjuster may comprise a bypass adjuster configured to provide an adjustment range for compression damping for high pressure and to provide an adjustment range for compression damping for low pressure. The fourth flow control element may be configured to provide an adjustment range of bypass flow of compression damping for high pressure and to provide an adjustment range of bypass flow of compression damping for low pressure. The adjuster may be configured to adjust compression damping; the adjuster configured to adjust compression damping may be configured to adjust a needle; the adjuster configured to adjust compression damping may comprise a dial configured to adjust the needle; the adjuster configured to adjust compression damping may comprise a dial at a knob configured to adjust the needle; the adjuster configured to adjust compression damping may comprise a dial configured to adjust the needle; the adjuster may be configured to adjust bypass flow; the adjuster configured to adjust bypass flow may be configured to adjust a needle; the adjuster configured to adjust bypass flow may comprise a knob configured to adjust the needle; the adjuster configured to adjust bypass flow may comprise a dial configured to adjust the needle; the control configured to provide a setting for compression damping may comprise a knob; the adjuster may be co-located with the control; the adjuster may comprise a dial co-located with the control; the adjuster may comprise a dial co-located with a knob for the control; the adjuster configured to adjust bypass flow may be co-located with the control configured to provide a setting for compression damping.

An improved suspension fork assembly configured to provide for compression damping may comprise a first flow control element configured for operation at an independent first setting of compression damping and a second flow control element configured for operation at an independent second setting of compression damping and a third flow control element configured to operation at an independent third setting of compression damping.

### Exemplary Embodiments—B

According to an exemplary embodiment shown schematically in the FIGURES, a suspension system configured to provide for compression damping may comprise a first flow control element configured for operation at a first setting of compression damping; a second flow control element configured for operation at a second setting of compression damping; a third flow control element configured to operation at a third setting of compression damping; the first setting is independent of the second setting and the third setting; the second setting is independent of the first setting and third setting; the third setting is independent of the first setting and the second setting. When the first flow control element is open compression damping is provided in a lockout condition; when the second flow control element is open compression damping is provided at a firm performance; when the third flow control element is open compression damping is provided at a soft performance. The system may comprise a control for a setting for compression damping; the setting for compression damping may comprise (a) a first setting for the first flow control element or (c) a second setting for the second flow control element or (b) a third setting for the third flow control element; the first setting is selectable independent of the second setting and the third setting; the second setting is selectable independent of the first setting and the third setting; the third setting is selectable independent of the first setting and the second setting. The system may comprise a fourth flow control element configured to modify bypass flow. The system may comprise a control for a setting for compression damping; the setting may comprise (a) a lockout setting with the first flow control element set to open when the pressure is at the value determined for a blowoff condition or (b) a firm suspension setting with the second flow control element set to open when the pressure is at the value determined for firm suspension performance or (c) a soft suspension setting with the third flow control element set to open when the pressure is at the value determined for soft suspension performance. The first flow control element may comprise a shim stack; the second flow control element may comprise a shim stack; the third flow control element may comprise a shim stack. The system may comprise a control comprising a knob configured to provide a setting for compression damping. The system may comprise an adjuster configured to provide adjustment for bypass flow for compression damping comprising a dial co-located with the knob. The system may comprise an adjuster for compression damping configured to actuate a needle valve.

According to an exemplary embodiment shown schematically in the FIGURES, a suspension system comprising a chamber configured to provide for compression damping in response to pressure in the chamber may comprise a first flow control element configured to open when the pressure is at a first value and a second flow control element configured to open when the pressure is at a second value and a third flow control element configured to open when the pressure is at a third value; the first value for the first flow control element is independent of the second value for the second flow control element and the third value for the third flow control element; the second value for the second flow control element is independent of the first value for the first flow control element and the third value for the third flow control element; the third value for the third flow control element is independent of the first value for the first flow control element and the second value for the second flow control element. The system may comprise a control for selecting a setting for compression damping; the setting may comprise (a) a lockout setting with the first flow control element set to open when the pressure is at a value determined for a blowoff condition or (b) a firm suspension setting with the second flow control element set to open when the pressure is at a value determined for firm suspension performance or (c) a soft suspension setting with the third flow control element set to open when the pressure is at a value determined for soft suspension performance. The system may comprise an adjuster is configured to provide a range of operation for suspension performance at a setting of compression damping. The system may comprise an control configured to provide a setting for compression damping; the setting for compression damping may comprise a first setting of suspension performance and a second setting of suspension performance and a third setting of suspension performance. A setting for compression damping may comprise independent settings comprising a setting for lockout and a setting for firm suspension performance and a setting soft suspension performance. The first flow control element is configured to open when pressure is at a relatively higher threshold value above an intermediate threshold value for a first suspension performance; he second flow control element is configured to open when pressure is at the intermediate threshold value for a second suspension performance; the third flow control element is configured to open when pressure is at a relatively lower threshold value below the intermediate threshold value for a third suspension performance. The first flow control element is configured to operate at a setting to open when the pressure is at a value determined for a blowoff condition; the second flow control element configured to operate at a setting to open when the pressure is at a value determined for firm suspension performance; the third flow control element is configured to operate at a setting to open when the pressure is at a value determined for soft suspension performance. The system may comprise an adjuster configured to adjust compression damping comprising a dial at a knob configured to adjust a needle valve. The first flow control element may comprise a shim stack selectably adjustable independently from the second flow control element; the first flow control element is selectably adjustable independently from the third flow control element; the second flow control element may comprise a shim stack selectably adjustable independently from the third flow control element; the third flow control element may comprise a shim stack.

According to an exemplary embodiment shown schematically in the FIGURES, a suspension system comprising a chamber configured to provide for compression damping may comprise a first flow control element [FCa] configured for operation at a first setting of compression damping and a second flow control element [FCb] configured for operation at a second setting of compression damping and a third flow control element [FCc] configured for operation at a third setting of compression damping and a fourth flow control element [FCd] configured to modify the pressure produced in the chamber by stroke velocity; the first flow control element is independent of the second flow control element and the third flow control element; the second flow control element is independent of the first flow control element and the third flow control element; the third flow control element is independent of the first flow control element and the second flow control element; the first setting is selectable independent of the second setting and the third setting; the second setting is selectable independent of the first setting and the third setting; the third setting is selectable independent of the first setting and the second setting. The system may comprise an adjuster for the fourth flow control element [FCd]; the adjuster is configured to provide a range of adjustment for firm suspension performance at a firm suspension setting and a range of adjustment for soft suspension performance at a soft suspension setting.

According to an exemplary embodiment shown schematically in the FIGURES, a suspension system comprising a suspension fork assembly configured to provide for compression damping may comprise a first flow control element for a first setting of compression damping and a second flow control element for a second setting of compression damping and a third flow control element for a third setting of compression damping; each flow control element is independent; each flow control element is independently selectable. Each flow control element may comprise a shim stack. A control may be configured to provide a setting for compression damping. The system may comprise an adjuster configured to provide adjustment for bypass flow for compression damping and/or to actuate a needle valve. The system may comprise an adjuster configured to provide a range of adjustment for firm suspension performance at a firm suspension setting and a range of adjustment for soft suspension performance at a soft suspension setting.

TABLE B
REFERENCE SYMBOL LIST

| REFERENCE | |
|---|---|
| SYMBOL | ELEMENT, PART OR COMPONENT |
| B | BICYCLE |
| FR | FRAME |
| FW | FRONT WHEEL |
| RW | REAR WHEEL |
| SP | SEAT POST |
| S | SEAT |
| T | STEERING TUBE |
| ST | STEM |
| H | HANDLEBAR |
| G | GRIP (HANDLEBAR) |
| F | FRONT FORK ASSEMBLY |
| SH | REAR SHOCK ABSORBER FOR SUSPENSION |
| | SYSTEM |
| BR | BRAKE SYSTEM |
| D | DISC/ROTOR (BRAKE) |
| P | PEDAL |
| RH | REAR HUB |
| RL | REMOTE LEVER |
| OC | OPERATOR CONTROL (COMPRESSION DAMPING) |
| DL | LEG (DAMPER LEG) |
| SL | LEG (SPRING LEG). |

TABLE C
REFERENCE SYMBOL LIST

| REFERENCE | |
|---|---|
| SYMBOL | ELEMENT, PART OR COMPONENT |
| 100 | DAMPER ASSEMBLY |
| 102 | ADJUSTMENT CONTROL (DIAL) |
| | (LOW SPEED ADJUSTER) |
| 102a | PROTRUSION (LOW SPEED ADJUSTER) |
| 104 | O-RING |
| 106 | SETTING CONTROL (KNOB) |
| | (COMPRESSION DAMPING SETTING) |
| 106a | PROTRUSION (COMPRESSION DAMPING |
| | SETTING) |
| 108 | SEAL |
| 110 | NUT |
| 112 | UPPER ASSEMBLY |
| 120 | LOWER ASSEMBLY |
| 122 | REBOUND ADJUSTER KNOB |
| 124 | SCREW |
| 126 | TOPCAP |
| 130 | COMPRESSION ASSEMBLY |
| 132 | TOPCAP |
| 134 | BLEED SCREW |
| 136 | O-RING |
| 138 | O-RING |
| 140 | LOW SPEED NEEDLE |
| 140a | TAPERED SURFACE (LOW SPEED NEEDLE) |
| 142 | SPRING |
| 144 | BALL |
| 146 | SEAL |
| 148 | VALVE SHAFT |
| 150 | RETAINING RING |
| 152 | O-RING |
| 154 | SELECTOR SHAFT |
| 154a | PASSAGE (SELECTOR SHAFT) |
| 154b | FIRST CENTER PASSAGE (SELECTOR SHAFT) |
| 154c | SECOND CENTER PASSAGE (SELECTOR SHAFT) |
| 154d | PORT (SELECTOR SHAFT) |
| 154f | CAM SLOT (SELECTOR SHAFT) |
| 156 | O-RING |
| 158 | RETAINING RING |
| 160 | COMPRESSION SHAFT |
| 160a | SURFACE (COMPRESSION SHAFT) |
| 160b | LOWER PORT (COMPRESSION SHAFT) |
| 160c | UPPER PORT (COMPRESSION SHAFT) |
| 160d | NEEDLE PORT (COMPRESSION SHAFT) |
| 160e | HOLE (COMPRESSION SHAFT) |
| 162 | PIN |
| 164 | SPRING |
| 166 | BALL |
| 168 | O-RING |
| 170 | POPPET |
| 170a | SURFACE (POPPET) |
| 172 | SPRING |
| 174 | CLAMP SHIM |
| 176 | SHIM |
| 178 | PISTON CUP |
| 178a | PORT (PISTON CUP) |
| 180 | SHIM |
| 182 | CLAMP SHIM |
| 184 | SHIM |
| 186 | PISTON |
| 186a | PASSAGE (PISTON) |
| 188 | O-RING |
| 190 | SHIM |
| 192 | SPRING SHIM |
| 194 | NUT |
| 194a | PASSAGE (NUT) |
| 200 | FIRST CHAMBER |
| 210 | SECOND CHAMBER. |

TABLE D
REFERENCE SYMBOL LIST

| REFERENCE | |
|---|---|
| SYMBOL | ELEMENT, PART OR COMPONENT |
| FCa | FLOW CONTROL ELEMENT A |
| | (LOCKOUT) |
| FCb | FLOW CONTROL ELEMENT B |
| | (COMPRESSION DAMPING SETTING) |
| FCc | FLOW CONTROL ELEMENT C |
| | (COMPRESSION DAMPING SETTING) |
| FCd | FLOW CONTROL ELEMENT D |
| | (ADJUSTER) |
| FPa | FLOW PASSAGE A |
| FPb | FLOW PASSAGE B |
| FPc | FLOW PASSAGE C |
| FPd | FLOW PASSAGE D |
| FPe | FLOW PASSAGE E |
| FPf | FLOW PASSAGE F |
| FPg | FLOW PASSAGE G |
| FPh | FLOW PASSAGE H |
| FPi | FLOW PASSAGE J |
| FPk | FLOW PASSAGE K |
| FPm | FLOW PASSAGE M |

It is important to note that the present inventions (e.g. inventive concepts, etc.) have been described in the specification and/or illustrated in the FIGURES of the present patent document according to exemplary embodiments; the embodiments of the present inventions are presented by way of example only and are not intended as a limitation on the scope of the present inventions. The construction and/or arrangement of the elements of the inventive concepts embodied in the present inventions as described in the specification and/or illustrated in the FIGURES is illustrative only. Although exemplary embodiments of the present inventions have been described in detail in the present patent document, a person of ordinary skill in the art will readily appreciate that equivalents, modifications, variations, etc. of the subject matter of the exemplary embodiments and alternative embodiments are possible and contemplated as being within the scope of the present inventions; all such subject matter (e.g. modifications, variations, embodiments, combinations, equivalents, etc.) is intended to be included within the scope of the present inventions. It should also be noted that various/other modifications, variations, substitutions, equivalents, changes, omissions, etc. may be made in the configuration and/or arrangement of the exemplary embodiments (e.g. in concept, design, structure, apparatus, form, assembly, construction, means, function, system, process/method, steps, sequence of process/method steps, operation, operating conditions, performance, materials, composition, combination, etc.) without departing from the scope of the present inventions; all such subject matter (e.g. modifications, variations, embodiments, combinations, equivalents, etc.) is intended to be included within the scope of the present inventions. The scope of the present inventions is not intended to be limited to the subject matter (e.g. details, structure, functions, materials, acts, steps, sequence, system, result, etc.) described in the specification and/or illustrated in the FIGURES of the present patent document. It is contemplated that the claims of the present patent document will be construed properly to cover the complete scope of the subject matter of the present inventions (e.g. including any and all such modifications, variations, embodiments, combinations, equivalents, etc.); it is to be understood that the terminology used in the present patent document is for the purpose of providing a description of the subject matter of the exemplary embodiments rather than as a limitation on the scope of the present inventions.

It is also important to note that according to exemplary embodiments the present inventions may comprise conventional technology (e.g. as implemented and/or integrated in exemplary embodiments, modifications, variations, combinations, equivalents, etc.) or may comprise any other applicable technology (present and/or future) with suitability and/or capability to perform the functions and processes/operations described in the specification and/or illustrated in the FIGURES. All such technology (e.g. as implemented in embodiments, modifications, variations, combinations, equivalents, etc.) is considered to be within the scope of the present inventions of the present patent document.

The invention claimed is:

1. A suspension system configured to provide for compression damping comprising:
(a) a first flow control element configured for operation at a first setting of compression damping;
(b) a second flow control element configured for operation at a second setting of compression damping;
(c) a third flow control element configured to operation at a third setting of compression damping;
wherein the first setting is independent of the second setting and the third setting;
wherein the second setting is independent of the first setting and third setting;
wherein the third setting is independent of the first setting and the second setting.

2. The system of claim 1 wherein when the first flow control element is open compression damping is provided in a lockout condition; wherein when the second flow control element is open compression damping is provided at a firm performance; wherein when the third flow control element is open compression damping is provided at a soft performance.

3. The system of claim 1 further comprising a control for a setting for compression damping; wherein the setting for compression damping comprises (1) a first setting for the first flow control element or (2) a second setting for the second flow control element or (3) a third setting for the third flow control element; wherein the first setting is selectable independent of the second setting and the third setting; wherein the second setting is selectable independent of the first setting and the third setting; wherein the third setting is selectable independent of the first setting and the second setting.

4. The system of claim 1 further comprising a fourth flow control element configured to modify bypass flow.

5. The system of claim 1 further comprising a control for a setting for compression damping; wherein the setting comprises (1) a lockout setting with the first flow control element set to open when the pressure is at the value determined for a blowoff condition or (2) a firm suspension setting with the second flow control element set to open when the pressure is at the value determined for firm suspension performance or (3) a soft suspension setting with the third flow control element set to open when the pressure is at the value determined for soft suspension performance.

6. The system of claim 1 wherein the first flow control element comprises a shim stack; wherein the second flow control element comprises a shim stack; wherein the third flow control element comprises a shim stack.

7. The system of claim 1 further comprising a control comprising a knob configured to provide a setting for compression damping.

8. The system of claim 7 further comprising an adjuster configured to provide adjustment for bypass flow for compression damping comprising a dial co-located with the knob.

9. The system of claim 1 further comprising an adjuster for compression damping configured to actuate a needle valve.

10. A suspension system comprising a chamber configured to provide for compression damping in response to pressure in the chamber comprising:
(a) a first flow control element configured to open when the pressure is at a first value;
(b) a second flow control element configured to open when the pressure is at a second value;
(c) a third flow control element configured to open when the pressure is at a third value;
wherein the first value for the first flow control element is independent of the second value for the second flow control element and the third value for the third flow control element;
wherein the second value for the second flow control element is independent of the first value for the first flow control element and the third value for the third flow control element;
wherein the third value for the third flow control element is independent of the first value for the first flow control element and the second value for the second flow control element.

11. The system of claim 10 further comprising a control for selecting a setting for compression damping; wherein the setting comprises (1) a lockout setting with the first flow control element set to open when the pressure is at a value determined for a blowoff condition or (2) a firm suspension setting with the second flow control element set to open when the pressure is at a value determined for firm suspension performance or (3) a soft suspension setting with the third flow control element set to open when the pressure is at a value determined for soft suspension performance.

12. The system of claim 10 further comprising an adjuster is configured to provide a range of operation for suspension performance at a setting of compression damping.

13. The system of claim 10 further comprising a control configured to provide a setting for compression damping; wherein the setting for compression damping comprises a first setting of suspension performance and a second setting of suspension performance and a third setting of suspension performance.

14. The system of claim 10 wherein a setting for compression damping comprises independent settings comprising a setting for lockout and a setting for firm suspension performance and a setting soft suspension performance.

15. The system of claim 10 wherein:
(a) the first flow control element is configured to open when pressure is at a relatively higher threshold value above an intermediate threshold value for a first suspension performance;
(b) the second flow control element is configured to open when pressure is at the intermediate threshold value for a second suspension performance;
(c) the third flow control element is configured to open when pressure is at a relatively lower threshold value below the intermediate threshold value for a third suspension performance.

16. The system of claim 10 wherein the first flow control element is configured to operate at a setting to open when the pressure is at a value determined for a blowoff condition; wherein the second flow control element configured to operate at a setting to open when the pressure is at a value determined for firm suspension performance; wherein the third flow control element is configured to operate at a setting to open when the pressure is at a value determined for soft suspension performance.

17. The system of claim 10 further comprising an adjuster configured to adjust compression damping comprising a dial at a knob configured to adjust a needle valve.

18. The system of claim 10 wherein the first flow control element comprises a shim stack selectably adjustable independently from the second flow control element; wherein the first flow control element is selectably adjustable independently from the third flow control element; wherein the second flow control element comprises a shim stack selectably adjustable independently from the third flow control element; wherein the third flow control element comprises a shim stack.

19. A suspension system comprising a chamber configured to provide for compression damping comprising:
(a) a first flow control element [FCa] configured for operation at a first setting of compression damping;
(b) a second flow control element [FCb] configured for operation at a second setting of compression damping;
(c) a third flow control element [FCc] configured for operation at a third setting of compression damping;
(d) a fourth flow control element [FCd] configured to modify the pressure produced in the chamber by stroke velocity;
wherein the first flow control element is independent of the second flow control element and the third flow control element;
wherein the second flow control element is independent of the first flow control element and the third flow control element;
wherein the third flow control element is independent of the first flow control element and the second flow control element;
wherein the first setting is selectable independent of the second setting and the third setting;
wherein the second setting is selectable independent of the first setting and the third setting;
wherein the third setting is selectable independent of the first setting and the second setting.

20. The system of claim 19 further comprising an adjuster for the fourth flow control element [FCd]; wherein the adjuster is configured to provide a range of adjustment for firm suspension performance at a firm suspension setting and a range of adjustment for soft suspension performance at a soft suspension setting.
